(19) United States
(12) Patent Application Publication
(10) Pub. No.: US 2026/0291795 A1
(43) Pub. Date: Sep. 24, 2026

(54) UE-INITIATED BEAM OPERATION PROCEDURES

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/553,192

(22) Filed: Feb. 27, 2026

Related U.S. Application Data
(60) Provisional application No. 63/773,872, filed on Mar. 18, 2025.
(60) Provisional application No. 63/812,578, filed on May 27, 2025.

(51) Int. Cl. H04L 27/26; H04B 7/06; H04B 17/318

(52) U.S. Cl. CPC H04L 27/261; H04B 7/0626; H04B 7/06968; H04B 17/328

(57) ABSTRACT

Methods and apparatuses for user equipment (UE) initiated beam operation procedures. A method performed by a UE includes receiving a set of one or more first reference signal (RS) resources for determining an event instance, receiving a transmission configuration indication (TCI) state, and determining a second RS resource specific to the TCI state based on the set of the one or more first RS resources. Each resource in the set is associated with an entity identity (ID). The method further includes identifying a serving entity ID associated with the second RS resource, identifying a first RS resource associated with the serving entity ID, and determining the event instance based on the second RS resource and the identified first RS resource.

### CROSS-REFERENCE TO RELATED AND CLAIM OF PRIORITY

The present application claims priority under 35 U.S.C. § 119(e) to U.S. Provisional Patent Application No. 63/773,872 filed on Mar. 18, 2025 and U.S. Provisional Patent Application No. 63/812,578 filed on May 27, 2025, which are hereby incorporated by reference in their entirety.

### TECHNICAL FIELD

The present disclosure relates generally to wireless communication systems and, more specifically, the present disclosure is related to a method and apparatus for user equipment (UE) initiated beam operation procedures.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for UE-initiated beam operation procedures.

In one embodiment, a UE is provided. The UE includes a transceiver configured to receive a set of one or more first reference signal (RS) resources for determining an event instance and receive a transmission configuration indication (TCI) state. Each resource in the set is associated with an entity identity (ID). The UE further includes a processor operably coupled with the transceiver. The processor is configured to determine a second RS resource specific to the TCI state based on the set of the one or more first RS resources, identify a serving entity ID associated with the second RS resource, identify a first RS resource associated with the serving entity ID, and determine the event instance based on the second RS resource and the identified first RS resource.

In another embodiment, a base station (BS) is provided. The BS includes a processor and a transceiver operably coupled with the processor. The transceiver is configured to transmit a set of one or more first RS resources for an event instance and transmit a TCI state. Each resource in the set is associated with an entity ID. A second RS resource specific to the TCI state is based on the set of the one or more first RS resources. A serving entity ID is associated with the second RS resource. A first RS resource is associated with the serving entity ID. The event instance is based on the second RS resource and the first RS resource.

In yet another embodiment, a method performed by a UE is provided The method includes receiving a set of one or more first RS resources for determining an event instance, receiving a TCI state, and determining a second RS resource specific to the TCI state based on the set of the one or more first RS resources. Each resource in the set is associated with an entity ID. The method further includes identifying a serving entity ID associated with the second RS resource, identifying a first RS resource associated with the serving entity ID, and determining the event instance based on the second RS resource and the identified first RS resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure;

FIGS. 7-9 illustrate examples of timing relations between/of a current serving beam RS(s)/RS resource(s), candidate/new beam RS(s)/RS resource(s), and event evaluation(s)/event evaluation instance(s) according to embodiments of the present disclosure;

FIGS. 10 and 11 illustrate examples of PUCCH transmission procedures in relation to TCI state updates according to embodiments of the present disclosure; and

FIG. 12 illustrates an example method performed by a UE in a wireless communication system according to embodiments of the present disclosure.

### DETAILED DESCRIPTION

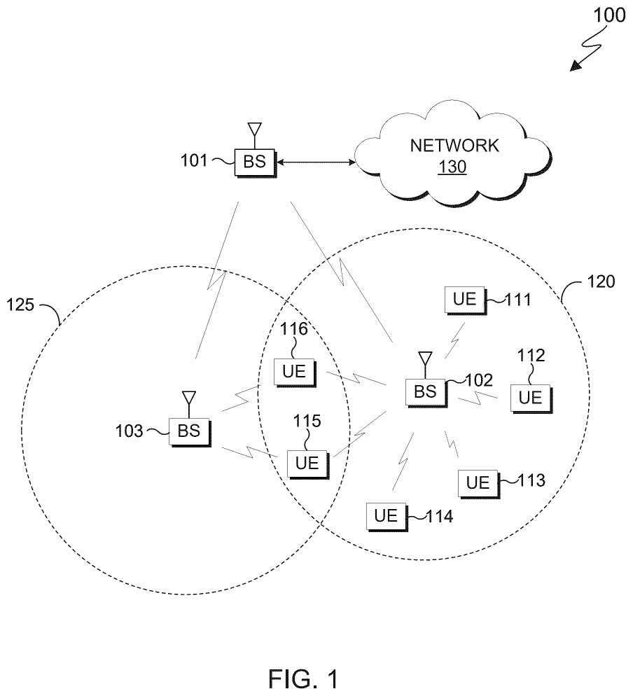

FIGS. 1-12 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mauve) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (Comp), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v16.1.0, “NR; Physical channels and modulation” (herein, “REF 1”); 3GPP TS 38.212 v16.1.0, “NR; Multiplexing and Channel coding” (herein, “REF 2”); 3GPP TS 38.213 v16.1.0, “NR; Physical Layer Procedures for Control” (herein, “REF 3”); 3GPP TS 38.214 v16.1.0, “NR; Physical Layer Procedures for Data” (herein, “REF 4”); 3GPP TS 38.321 v16.1.0, “NR; Medium Access Control (MAC) protocol specification” (herein, “REF 5”); and 3GPP TS 38.331 v16.1.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE-initiated beam operation procedures. In certain embodiments, one or more of the BSs 101-103 include circuitry, programing, or a combination thereof to support UE-initiated beam operation procedures.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

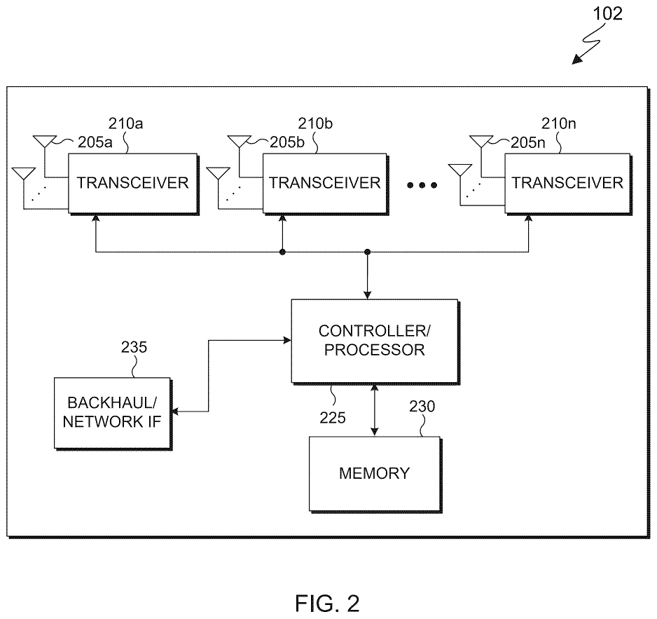

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support UE-initiated beam operation procedures. Any of a wide variety of other functions could be supported in the BS 102 by the controller/processor 225.

The controller/processor 225 is also capable of executing programs and other processes resident in the memory 230, such as processes to support UE-initiated beam operation procedures. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

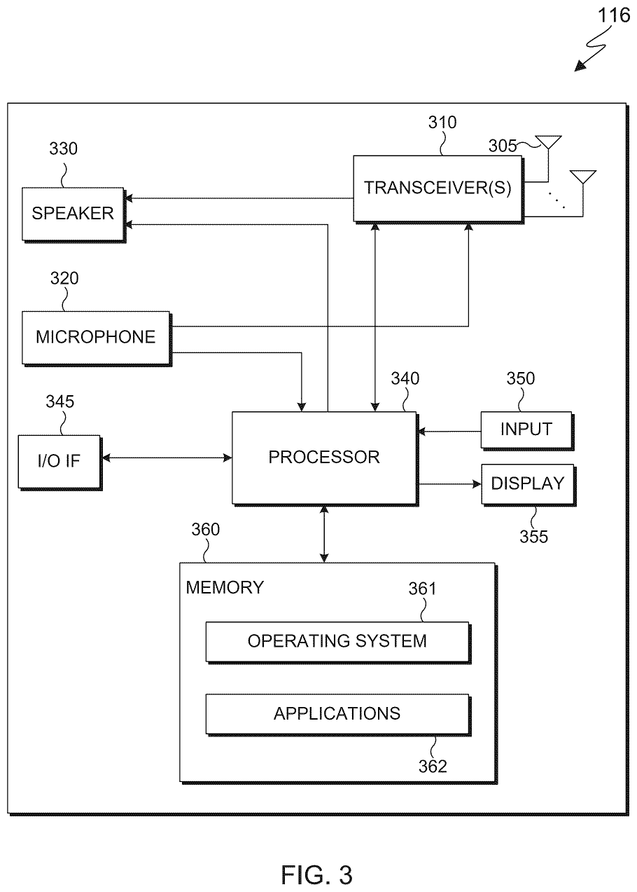

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing UE-initiated beam operation procedures as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

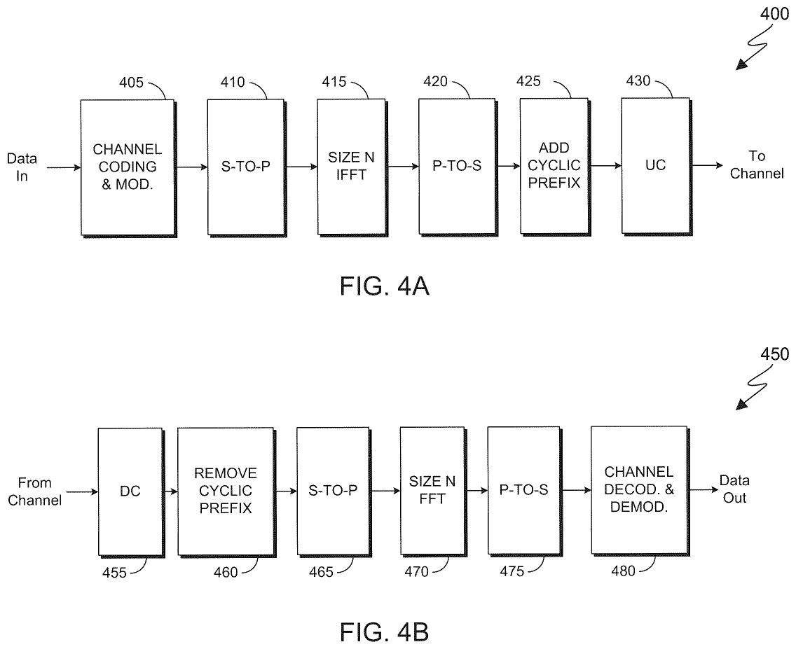

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting UE-initiated beam operation procedures as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

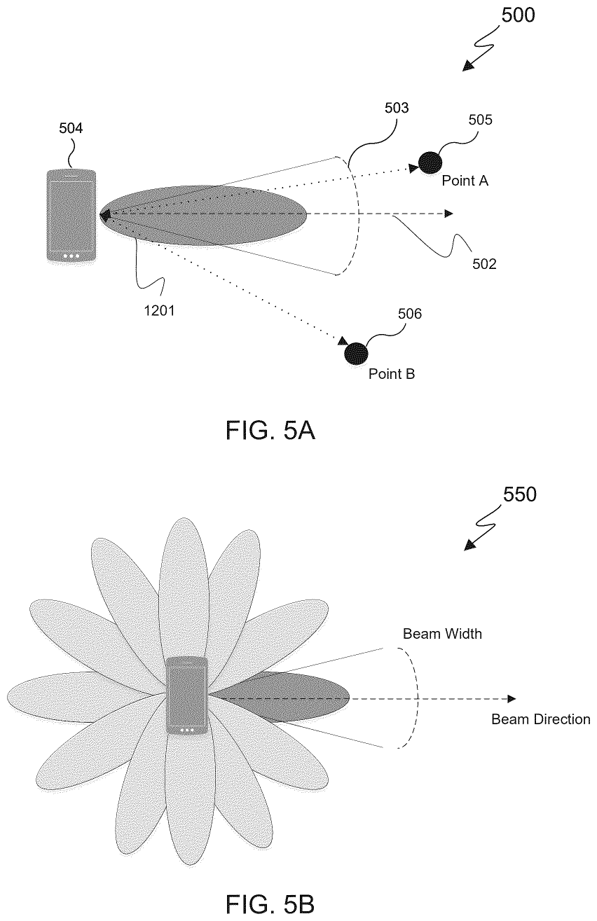

FIG. 5A illustrates an example beam operation 500 in a wireless communication system according to embodiments of the present disclosure. For example, beam operation 500 can be implemented by BS 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 5A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by BS 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art, that beams can be 3D, where the beams can be transmitted to or received from any direction in space.

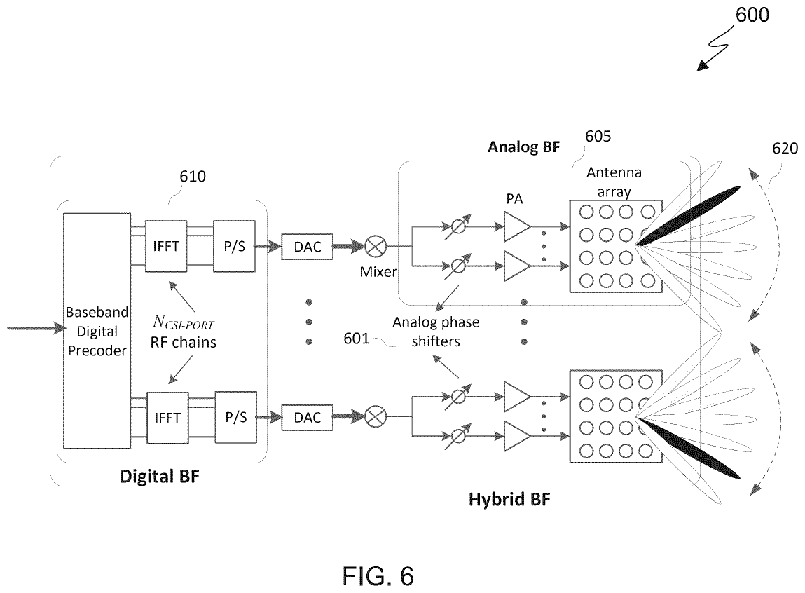

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

In NR specifications, up to Rel-17, the most resource-efficient reporting mechanism for a content (e.g., beam, CSI, etc., or in general different report quantities) is aperiodic (in conjunction with aperiodic CSI-RS). However, with a well-chosen periodicity, periodic reporting (followed by semi-persistent) results in the lowest latency at the expense of resources. Although aperiodic reporting seems preferred from the overall operational perspective, in a few relevant scenarios, the network (NW)/gNB lacks knowledge on the DL channel condition; in other words, the UE knows the DL channel condition better. In this case, it is clearly beneficial if the UE can initiate its own aperiodic reporting for a content (e.g., beam, CSI, etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from traditional beam or CSI reports) and application scenarios.

Although UE-initiated/event-driven reporting can be beneficial, efficient methods and apparatuses are needed to ensure that the latency is reduced and, at the same time, error events can be minimized. Therefore, there is a need for efficient methods and apparatuses for UE-initiated/event-driven reporting for a content that can offer a good trade-off between latency and reliability, particularly when the UE-initiated/event-driven beam management framework can include multiple report types (or report quantities), and/or multiple event types when a report type can be associated with an event (e.g., for beam report, the event can be beam failure, and for CSI, the event can be user throughput degradation or increasing retransmission rate). UE-initiated/event-driven beam reporting may also facilitate beam switching or fast beam switching.

The present disclosure provides various novel and detailed examples on the UE-initiated/event-driven beam management framework including UE-initiated/event-driven beam reporting. To better support/enable the UE-initiated and the event-based beam operations, the present disclosure presents example embodiments on means and/or procedures of transmitting the UE-initiated report(s) along with its indicator(s) via various uplink channels, as well as configuring and determining measurement RS resource(s) for the UE-initiated/event-driven beam operations. In addition, the present disclosure provides various report formats customized for the UE-initiated/event-driven beam reporting, and specifies different conditions or settings to apply or use for different report formats. Means of detecting/declaring different events or combinations of different events, and examples of their corresponding configurations and signaling details are also specified in the present disclosure.

In the present disclosure, a UE detects (or determines) a need for transmitting a UE-initiated/UE-triggered report (or initiation/triggering) of a (report-)type (A), (B), or (C), where:
(A) includes an initiator/trigger/pre-notification message
(B) includes a report/content (comprising one or multiple report quantities)
(C) includes both a trigger/pre-notification message and a (corresponding) report/content

The UE could send to the network the UE-initiated (UEI)/UE-triggered report of a (report-)type (A), (B) and/or (C) according to one or more of:
Fixed rule(s) in system specification(s): for example, the UE could always send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g., NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jₜ)}, where Iᵢ is an beam (source RS) indicator (e.g., CRI, SSBRI) and Jᵢ is a beam metric (e.g., L1-RSRP, L1-SINR).
In one example, the content includes CSI-related quantity/quantities. For example, at least one of (RI, PMI, CQI, CRI, LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-)correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either
      beam (TCI state) TCI states (e.g., DL TCI state, UL TCI state, or unified (joint) DL/UL TCI state), or
      panel(s) (e.g., UE panels for DL reception or/and UL transmission), or
      antenna(e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁*N₂ (e.g., this switching is for DL reception or/and UL transmission).
In one example, the content includes beam-related quantity/quantities (examples above) and at least one other quantity/quantities (examples above).
In one example, the content includes CSI-related quantity/quantities (examples above) and at least one other quantity/quantities (examples above).
In one example, the content includes TDCP-related quantity/quantities (examples above) and at least one other quantity/quantities (examples above).
In one example, the content includes beam-related quantity/quantities (examples above) and CSI-related quantity/quantities (examples above).
In one example, the content includes beam-related quantity/quantities (examples above) and TDCP-related quantity/quantities (examples above).
In one example, the content includes TDCP-related quantity/quantities (examples above) and CSI-related quantity/quantities (examples above).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). These tables are set forth below. In these examples, the event-types and the report-types are separate (explicit). However, they can also be Joint, as shown in Table 4 below. A few examples of the autonomous UE-initiated report are shown in Table 5 below.

TABLE 1
event-based UE-initiated report

| | Report | | |
|---|---|---|---|
| | | Trigger/ | |
| | | prenotifi- | |
| | | cation | Con- |
| Event type | Type | message | tent |
| 0: beam | (A) | Yes (e.g., | No |
| | | beam-related | |
| | | event) | |
| | (B) | No | Yes |
| | (C) | Yes (e.g., | Yes |
| | | beam-related | |
| | | event) | |
| 1: CSI | (A) | Yes (e.g., | No |
| | | CSI-related | |
| | | event) | |
| | (B) | No | Yes |
| | (C) | Yes (e.g., | Yes |
| | | CSI-related | |
| | | event) | |
| 2: TDCP | (A) | Yes (e.g., | No |
| | | TDCP-related | |
| | | event) | |
| | (B) | No | Yes |
| | (C) | Yes (e.g., | Yes |
| | | TDCP-related | |
| | | event) | |
| 3: non-CSI/beam/TDCP | (A) | Yes (e.g., non- | No |
| | | CSI-related | |
| | | event) | |
| | (B) | No | Yes |
| | (C) | Yes (e.g., non- | Yes |
| | | CSI-related | |
| | | event) | |
| 4. other (content-free/less events) | (A) | Yes (no need | No |
| | | for content) | |

TABLE 2
event-based UE-initiated report

| Event- | |
|---|---|
| type | Event |
| 0 | Beam-related |
| 1 | CSI-related |
| 2 | TDCP-related |
| 3 | Non-beam/CSI/TDCP |
| 4 | Other |

TABLE 3
event-based UE-initiated report

| | Trigger/pre- | |
|---|---|---|
| | notification | |
| Report-type | message | Content |
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), content- | No |
| | specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g., beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g., CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g., from Type I to Type II or vice versa), or rank restriction (e.g., from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g., CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g., MCS, or number of CWs.
For another example, when there is no pre-notification message/trigger associated with a content, i.e., the report-type is (B), the content can be transmitted using UL resource(s) configured (e.g., configured-grant PUSCH), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could always send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could always send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could always send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc.

In the present disclosure, configuration and determination of measurement RS resource(s) for UEI reporting is provided.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various example options/channels to indicate to the UE a beam (i.e., a TCI state) for the transmission/reception of a PDCCH or a PDSCH. As described in the 3GPP Rel-17:
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In the case of joint TCI state indication, wherein a same beam is used for DL and UL channels, a joint TCI state that can be used at least for UE-dedicated DL channels and UE-dedicated UL channels.
In the case of separate TCI state indication, wherein different beams are used for DL and UL channels, a DL TCI state can be used at least for UE-dedicated DL channels.
In the case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

Under the aforementioned unified TCI framework, a UE could receive a (unified) TCI state(s) activation/deactivation (MAC CE) command, used to map up to a number of activated TCI states and/or pairs of activated TCI states, with one activated TCI state for DL channels/signals and/or one activated TCI state for UL channels/signals to the codepoints of the DCI field ‘Transmission Configuration Indication’ for one or for a set of CCs/DL BWPs, and if applicable, for one or for a set of CCs/UL BWPs. That is, a UE could receive from the network, in/via a (unified) TCI state(s) activation/deactivation (MAC CE) command, up to a number of TCI codepoints of the DCI field ‘Transmission Configuration Indication’ for one or for a set of CCs/DL BWPs, and if applicable, for one or for a set of CCs/UL BWPs with each TCI codepoint mapped to an activated TCI state and/or a pair of activated TCI states, with one activated TCI state for DL channels/signals and/or one activated TCI state for UL channels/signals. In the present disclosure, an activated TCI state can also be referred to as an activated beam, and vice versa.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources as specified/defined herein in the present disclosure; furthermore, the UE could determine or identify the one or more activated beams/TCI states as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure. Here, the UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g., in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

When/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI, and when/if the UE determines the reference signal(s) including the CSI-RS(s) in the indicated joint/DL TCI state (or an activated joint/DL TCI state) as the current serving (or activation) beam RS(s) for event evaluation according to or following those specified/defined in Scheme-1, the UE could determine that the reference signal(s) including the CSI-RS(s) could be associated to a PCI according to one or more of:
In one example, the higher layer parameter(s) e.g., NZP-CSI-RS-Resource that configures or provides the reference signal(s)/CSI-RS(s) could comprise, include, configure or provide the PCI or a PCI index pointing to an entry (corresponding to the PCI) in a list/set/pool of PCIs higher layer configured or provided to the UE.
In another example, the UE could first determine or identify SSB(s) that is QCLed with the reference signal(s) including the CSI-RS(s) in the indicated joint/DL TCI state (or the activated joint/DL TCI state). Here, the SSB(s) could be (selected or determined) from an SSB resource set provided by csi-SSB-ResourceSet (e.g., provided or configured in a CSI-ResourceConfig associated to a CSI report configuration provided by CSI-ReportConfig that provides or configures necessary information and/or setting(s) including eventType for the UE-initiated/event-driven beam reporting as specified/defined herein in the present disclosure) comprising one or more SSBs, wherein the higher layer parameter csi-SSB-ResourceSet that provides or configures the SSB resource set could contain, provide, comprise or configure a set of one or more PCIs or PCI indexes each pointing to an entry (and therefore a corresponding PCI value) in a list/set/pool of PCIs higher layer provided or configured to the UE. In this case, the one or more SSBs in the SSB resource set could be one-to-one mapped to the one or more PCIs/PCI indexes in the PCI(s)/PCI index(es) set according to e.g., their ordinal positions in their respective sets. For instance, the first entry or the first SSB or the SSB with the lowest (or highest) SSB ID/index in the SSB resource set could be associated/mapped to the first entry or the first PCI/PCI index or the lowest (or highest) PCI/PCI index in the PCI(s)/PCI index(es) set, the second entry or the second SSB or the SSB with the second lowest (or second highest) SSB ID/index in the SSB resource set could be associated/mapped to the second entry or the second PCI/PCI index or the second lowest (or second highest) PCI/PCI index in the PCI(s)/PCI index(es) set, and so on, and the last entry or the last SSB or the SSB with the highest (or lowest) SSB ID/index in the SSB resource set could be associated/mapped to the last entry or the last PCI/PCI index or the highest (or lowest) PCI/PCI index in the PCI(s)/PCI index(es) set. For this example, the UE could first determine or identity the aforementioned SSB(s) from/in the SSB resource set provided by csi-SSB-ResourceSet, and determine or identify the PCI/PCI index in the PCI(s)/PCI index(es) set that is mapped to the aforementioned SSB(s); the UE could then determine or identify that the aforementioned reference signal(s) including the CSI-RS(s)—as the current serving (or activation) beam RS(s) for event evaluation—could be associated, mapped or specific to the determined or identified PCI/PCI index.
In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, a first set of one or more RS resources (e.g., in terms/form of their resource ID(s)/index(es))—e.g., provided by nzp-CSI-RS-ResourceSet—comprising the aforementioned reference signal(s) including the CSI-RS(s)—determined as the current serving (or activation) beam RS(s) for event evaluation, and a second set of one or more PCIs or PCI indexes each pointing to an entry (and therefore a corresponding PCI value) in a list/set/pool of PCIs higher layer configured or provided to the UE. For this example, the one or more RS resources in the first set could be one-to-one mapped to the one or more PCIs/PCI indexes in the second set according to e.g., their ordinal positions in their respective sets. For instance, the first entry or the first RS resource or the RS resource with the lowest (or highest) resource ID/index in the first set could be associated/mapped to the first entry or the first PCI/PCI index or the lowest (or highest) PCI/PCI index in the second set, the second entry or the second RS resource or the RS resource with the second lowest (or second highest) resource ID/index in the first set could be associated/mapped to the second entry or the second PCI/PCI index or the second lowest (or second highest) PCI/PCI index in the second set, and so on, and the last entry or the last RS resource or the RS resource with the highest (or lowest) resource ID/index in the first set could be associated/mapped to the last entry or the last PCI/PCI index or the highest (or lowest) PCI/PCI index in the second set. For this example, the UE could first determine or identity the aforementioned reference signal(s) including the CSI-RS(s)—as the current serving (or activation) beam RS(s) for event evaluation—from/in the first set, and then determine or identify the PCI/PCI index in the second set that is mapped to the aforementioned reference signal(s) including the CSI-RS(s).
In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, a first set of one or more RS resources (e.g., in terms/form of their resource ID(s)/index(es))—e.g., provided by nzp-CSI-RS-ResourceSet—comprising the aforementioned reference signal(s) including the CSI-RS(s)—determined as the current serving (or activation) beam RS(s) for event evaluation. In this case, the higher layer parameter(s) e.g., nzp-CSI-RS-ResourceSet that provides or configures the first set could comprise, contain, include, provide or configure a second set of one or more PCIs or PCI indexes each pointing to an entry (and therefore a corresponding PCI value) in a list/set/pool of PCIs higher layer configured or provided to the UE. For this example, the one or more RS resources in the first set could be one-to-one mapped to the one or more PCIs/PCI indexes in the second set according to e.g., their ordinal positions in their respective sets. For instance, the first entry or the first RS resource or the RS resource with the lowest (or highest) resource ID/index in the first set could be associated/mapped to the first entry or the first PCI/PCI index or the lowest (or highest) PCI/PCI index in the second set, the second entry or the second RS resource or the RS resource with the second lowest (or second highest) resource ID/index in the first set could be associated/mapped to the second entry or the second PCI/PCI index or the second lowest (or second highest) PCI/PCI index in the second set, and so on, and the last entry or the last RS resource or the RS resource with the highest (or lowest) resource ID/index in the first set could be associated/mapped to the last entry or the last PCI/PCI index or the highest (or lowest) PCI/PCI index in the second set. For this example, the UE could first determine or identity the aforementioned reference signal(s) including the CSI-RS(s)—as the current serving (or activation) beam RS(s) for event evaluation—from/in the first set, and then determine or identify the PCI/PCI index in the second set that is mapped to the aforementioned reference signal(s) including the CSI-RS(s).
In another example, when/if the reference signal(s) in the indicated joint/DL TCI state (or the activated joint/DL TCI state) is CSI-RS(s), the higher layer parameter(s) TCI-State that provides or configures the indicated (or activated) joint/DL TCI state could comprise, include, contain, provide or configure a PCI value or a PCI index pointing to an entry (and therefore, a corresponding PCI value) in a list/set/pool of PCIs higher layer configured or provided to the UE. For this example, the aforementioned reference signal(s) including the CSI-RS(s)—determined as the current serving (or activation) beam RS(s) for event evaluation—could be associated to the PCI/PCI index comprised, contained, included, provided or configured in the higher layer parameter e.g., TCI-State that provides or configures the same indicated (or activated) joint/DL TCI state. That is, for this example, when/if the reference signal(s) in the indicated (or activated) joint/DL TCI state is CSI-RS(s) rather than SSB(s), the higher layer parameter(s) TCI-State that provides or configures the indicated (or activated) joint/DL TCI state could still comprise, include, contain, provide or configure a PCI value or a PCI index pointing to an entry (and therefore, a corresponding PCI value) in a list/set/pool of PCIs higher layer configured or provided to the UE; in this case, the UE could determine or identify that the CSI-RS(s) in the indicated (or activated) joint/DL TCI state—as the current serving (or activation) beam RS(s) or RS resource(s)—could be associated to the PCI/PCI index comprised, contained, included, provided or configured in the higher layer parameter e.g., TCI-State that provides or configures the same indicated (or activated) joint/DL TCI state.
In another example, the higher layer parameter(s) nzp-CSI-RS-ResourceSet that provides or configures a NZP CSI-RS resource set that comprises the candidate/new beam RS(s) or RS resource(s) or RS resource (configuration) index(es) in the set provided by the higher layer parameter newBeamResourceSet-r19 could also comprise, contain, include, provide or configure the aforementioned CSI-RS(s)—determined as the current serving (or activation) beam RS(s) for event evaluation. In this case, the bitwidth of a CRI corresponding to a/the current serving (or activation) beam RS or RS resource and/or the bitwidth of a CRI corresponding to a candidate/new beam RS or RS resource could be ┌log₂K┐, where K represents a/the number of CSI-RS(s) or CSI-RS resource(s) in the NZP CSI-RS resource set. Furthermore, the higher layer parameter nzp-CSI-RS-ResourceSet that provides or configures the NZP CSI-RS resource set could also contain, provide, comprise or configure a set of one or more PCIs or PCI indexes each pointing to an entry (and therefore a corresponding PCI value) in a list/set/pool of PCIs higher layer provided or configured to the UE. In this case, the one or more CSI-RSs/CSI-RS resources in the NZP CSI-RS resource set could be one-to-one mapped to the one or more PCIs/PCI indexes in the PCI(s)/PCI index(es) set according to e.g., their ordinal positions in their respective sets. For instance, the first entry or the first CSI-RS/CSI-RS resource or the CSI-RS/CSI-RS resource with the lowest (or highest) RS/resource ID/index in the NZP CSI-RS resource set could be associated/mapped to the first entry or the first PCI/PCI index or the lowest (or highest) PCI/PCI index in the PCI(s)/PCI index(es) set, the second entry or the second CSI-RS/CSI-RS resource or the CSI-RS/CSI-RS resource with the second lowest (or second highest) RS/resource ID/index in the NZP CSI-RS resource set could be associated/mapped to the second entry or the second PCI/PCI index or the second lowest (or second highest) PCI/PCI index in the PCI(s)/PCI index(es) set, and so on, and the last entry or the last CSI-RS/CSI-RS resource or the CSI-RS/CSI-RS resource with the highest (or lowest) RS/resource ID/index in the NZP CSI-RS resource set could be associated/mapped to the last entry or the last PCI/PCI index or the highest (or lowest) PCI/PCI index in the PCI(s)/PCI index(es) set. For this example, the UE could first determine or identity the aforementioned CSI-RS(s)—as the current serving (or activation) beam RS(s) for event evaluation—from/in the NZP CSI-RS resource set provided by nzp-CSI-RS-ResourceSet, and then determine or identify the PCI/PCI index (e.g., with/having value 0 corresponding to the serving cell PCI or the PCI to which the NZP CSI-RS resource set provided by nzp-CSI-RS-ResourceSet is applied) in the PCI(s)/PCI index(es) set that is mapped to the aforementioned CSI-RS(s). Alternatively, the aforementioned PCI—associated, mapped or specific to the CSI-RS(s) as the current serving (or activation) beam RS(s) or RS resource(s)—could correspond to a/the PCI to which the NZP CSI-RS resource set provided by nzp-CSI-RS-ResourceSet is applied.
In another example, the aforementioned PCI—associated, mapped or specific to the CSI-RS(s) as the current serving (or activation) beam RS(s) or RS resource(s)—can be a/the serving cell PCI or an additional PCI other than the serving cell PCI.

When/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI, and when/if the UE determines the SSB(s) that is QCL'ed with the reference signal(s) including the CSI-RS(s) in the indicated (or activated) joint/DL TCI state as the current serving (or activation) beam RS(s) for event evaluation according to or following those specified/defined in Scheme-2, the UE could determine that the SSB(s) could be associated to a PCI according to one or more of:
In one example, the higher layer parameter(s) that configures or provides the SSB(s) could comprise, include, configure or provide the PCI or a PCI index pointing to an entry (corresponding to the PCI) in a list/set/pool of PCIs higher layer configured or provided to the UE.
In another example, the SSB(s) could be (selected or determined) from an SSB resource set provided by csi-SSB-ResourceSet (e.g., provided or configured in a CSI-ResourceConfig associated to a CSI report configuration provided by CSI-ReportConfig that provides or configures necessary information and/or setting(s) including eventType for the UE-initiated/event-driven beam reporting as specified/defined herein in the present disclosure) comprising one or more SSBs, wherein the higher layer parameter csi-SSB-ResourceSet that provides or configures the SSB resource set could contain, provide, comprise or configure a set of one or more PCIs or PCI indexes each pointing to an entry (and therefore a corresponding PCI value) in a list/set/pool of PCIs higher layer provided or configured to the UE. In this case, the one or more SSBs in the SSB resource set could be one-to-one mapped to the one or more PCIs/PCI indexes in the PCI(s)/PCI index(es) set according to e.g., their ordinal positions in their respective sets. For instance, the first entry or the first SSB or the SSB with the lowest (or highest) SSB ID/index in the SSB resource set could be associated/mapped to the first entry or the first PCI/PCI index or the lowest (or highest) PCI/PCI index in the PCI(s)/PCI index(es) set, the second entry or the second SSB or the SSB with the second lowest (or second highest) SSB ID/index in the SSB resource set could be associated/mapped to the second entry or the second PCI/PCI index or the second lowest (or second highest) PCI/PCI index in the PCI(s)/PCI index(es) set, and so on, and the last entry or the last SSB or the SSB with the highest (or lowest) SSB ID/index in the SSB resource set could be associated/mapped to the last entry or the last PCI/PCI index or the highest (or lowest) PCI/PCI index in the PCI(s)/PCI index(es) set. For this example, the UE could first determine or identity the aforementioned SSB(s)—as the current serving (or activation) beam RS(s) for event evaluation—from/in the SSB resource set provided by csi-SSB-ResourceSet, and then determine or identify the PCI/PCI index in the PCI(s)/PCI index(es) set that is mapped to the aforementioned SSB(s).
In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, a first set of one or more SSBs (e.g., in terms/form of their SSB ID(s)/index(es))—e.g., provided by csi-SSB-ResourceSet—comprising the aforementioned SSB(s)—determined as the current serving (or activation) beam RS(s) for event evaluation. In this case, the higher layer parameter(s) e.g., csi-SSB-ResourceSet that provides or configures the first set could comprise, contain, include, provide or configure a second set of one or more PCIs or PCI indexes each pointing to an entry (and therefore a corresponding PCI value) in a list/set/pool of PCIs higher layer configured or provided to the UE. For this example, the one or more SSBs in the first set could be one-to-one mapped to the one or more PCIs/PCI indexes in the second set according to e.g., their ordinal positions in their respective sets. For instance, the first entry or the first SSB or the SSB with the lowest (or highest) SSB ID/index in the first set could be associated/mapped to the first entry or the first PCI/PCI index or the lowest (or highest) PCI/PCI index in the second set, the second entry or the second SSB or the SSB with the second lowest (or second highest) SSB ID/index in the first set could be associated/mapped to the second entry or the second PCI/PCI index or the second lowest (or second highest) PCI/PCI index in the second set, and so on, and the last entry or the last SSB or the SSB with the highest (or lowest) SSB ID/index in the first set could be associated/mapped to the last entry or the last PCI/PCI index or the highest (or lowest) PCI/PCI index in the second set. For this example, the UE could first determine or identity the aforementioned SSB(s)—as the current serving (or activation) beam RS(s) for event evaluation—from/in the first set, and then determine or identify the PCI/PCI index in the second set that is mapped to the aforementioned SSB(s).
In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, a first set of one or more SSBs (e.g., in terms/form of their SSB ID(s)/index(es))—e.g., provided by csi-SSB-ResourceSet—comprising the aforementioned SSB(s)—determined as the current serving (or activation) beam RS(s) for event evaluation, and a second set of one or more PCIs or PCI indexes each pointing to an entry (and therefore a corresponding PCI value) in a list/set/pool of PCIs higher layer configured or provided to the UE. For this example, the one or more SSBs in the first set could be one-to-one mapped to the one or more PCIs/PCI indexes in the second set according to e.g., their ordinal positions in their respective sets. For instance, the first entry or the first SSB or the SSB with the lowest (or highest) SSB ID/index in the first set could be associated/mapped to the first entry or the first PCI/PCI index or the lowest (or highest) PCI/PCI index in the second set, the second entry or the second SSB or the SSB with the second lowest (or second highest) SSB ID/index in the first set could be associated/mapped to the second entry or the second PCI/PCI index or the second lowest (or second highest) PCI/PCI index in the second set, and so on, and the last entry or the last SSB or the SSB with the highest (or lowest) SSB ID/index in the first set could be associated/mapped to the last entry or the last PCI/PCI index or the highest (or lowest) PCI/PCI index in the second set. For this example, the UE could first determine or identity the aforementioned SSB(s)—as the current serving (or activation) beam RS(s) for event evaluation—from/in the first set, and then determine or identify the PCI/PCI index in the second set that is mapped to the aforementioned SSB(s).
In another example, when/if the reference signal(s) in the indicated (or activated) joint/DL TCI state is CSI-RS(s), the higher layer parameter(s) TCI-State that provides or configures the indicated (or activated) joint/DL TCI state could comprise, include, contain, provide or configure a PCI value or a PCI index pointing to an entry (and therefore, a corresponding PCI value) in a list/set/pool of PCIs higher layer configured or provided to the UE. For this example, the aforementioned SSB(s)—determined as the current serving (or activation) beam RS(s) for event evaluation—could be associated to the PCI/PCI index comprised, contained, included, provided or configured in the higher layer parameter e.g., TCI-State that provides or configures the same indicated (or activated) joint/DL TCI state. That is, for this example, when/if the reference signal(s) in the indicated (or activated) joint/DL TCI state is CSI-RS(s) rather than SSB(s), the higher layer parameter(s) TCI-State that provides or configures the indicated (or activated) joint/DL TCI state could still comprise, include, contain, provide or configure a PCI value or a PCI index pointing to an entry (and therefore, a corresponding PCI value) in a list/set/pool of PCIs higher layer configured or provided to the UE; in this case, the UE may not expect that the CSI-RS(s) in the indicated (or activated) joint/DL TCI state is associated to the PCI/PCI index comprised, contained, included, provided or configured in the higher layer parameter e.g., TCI-State that provides or configures the same indicated (or activated) joint/DL TCI state.
In another example, the higher layer parameter(s) csi-SSB-ResourceSet that provides or configures an SSB resource set that comprises the candidate/new beam RS(s) or RS resource(s) or RS resource (configuration) index(es) in the set provided by the higher layer parameter newBeamResourceSet-r19 could also comprise, contain, include, provide or configure the aforementioned SSB(s)—determined as the current serving (or activation) beam RS(s) for event evaluation. In this case, the bitwidth of a SSBRI corresponding to a/the current serving (or activation) beam RS or RS resource and/or the bitwidth of a SSBRI corresponding to a candidate/new beam RS or RS resource could be ┌log₂K┐, where K represents a/the number of SSB(s)/SSB index(es) in the SSB resource set. Furthermore, the higher layer parameter csi-SSB-ResourceSet that provides or configures the SSB resource set could also contain, provide, comprise or configure a set of one or more PCIs or PCI indexes each pointing to an entry (and therefore a corresponding PCI value) in a list/set/pool of PCIs higher layer provided or configured to the UE. In this case, the one or more SSBs in the SSB resource set could be one-to-one mapped to the one or more PCIs/PCI indexes in the PCI(s)/PCI index(es) set according to e.g., their ordinal positions in their respective sets. For instance, the first entry or the first SSB or the SSB with the lowest (or highest) SSB ID/index in the SSB resource set could be associated/mapped to the first entry or the first PCI/PCI index or the lowest (or highest) PCI/PCI index in the PCI(s)/PCI index(es) set, the second entry or the second SSB or the SSB with the second lowest (or second highest) SSB ID/index in the SSB resource set could be associated/mapped to the second entry or the second PCI/PCI index or the second lowest (or second highest) PCI/PCI index in the PCI(s)/PCI index(es) set, and so on, and the last entry or the last SSB or the SSB with the highest (or lowest) SSB ID/index in the SSB resource set could be associated/mapped to the last entry or the last PCI/PCI index or the highest (or lowest) PCI/PCI index in the PCI(s)/PCI index(es) set. For this example, the UE could first determine or identity the aforementioned SSB(s)—as the current serving (or activation) beam RS(s) for event evaluation—from/in the SSB resource set provided by csi-SSB-ResourceSet, and then determine or identify the PCI/PCI index (e.g., with/having value 0 corresponding to the serving cell PCI or the PCI to which the SSB resource set provided by csi-SSB-ResourceSet is applied) in the PCI(s)/PCI index(es) set that is mapped to the aforementioned SSB(s). Alternatively, the aforementioned PCI—associated, mapped or specific to the SSB(s) as the current serving (or activation) beam RS(s) or RS resource(s)—could correspond to a/the PCI to which the SSB resource set provided by csi-SSB-ResourceSet is applied.
In another example, the aforementioned PCI—associated, mapped or specific to the SSB(s) as the current serving (or activation) beam RS(s) or RS resource(s)—can be a/the serving cell PCI or an additional PCI other than the serving cell PCI.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be provided in or associated with higher layer parameter(s) CSI-ReportConfig, CSI-ResourceConfig associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. More specifically, the UE could be configured with a set of candidate/new beam RS(s) or RS resource(s) or RS resource (configuration) index(es) provided by a higher layer parameter newBeamResourceSet-r19 for event(s) evaluation(s), wherein the set could comprise one or more NZP CSI-RS resources (e.g., in terms/form of their corresponding resource ID(s)/index(es)) from/in an NZP CSI-RS resource set provided by nzp-CSI-RS-ResourceSet, and/or one or more SS/PBCH blocks (e.g., in terms/form of their corresponding SSB ID(s)/index(es)) from/in a SSB resource set provided by csi-SSB-ResourceSet. When/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI, each of the candidate/new beam RS(s) or RS resource(s) or RS resource (configuration) index(es) in the set provided by newBeamResourceSet-r19 could be associated or mapped or specific to a same or different PCI value or a same or different PCI index pointing to an entry (hence, a corresponding PCI value) in a list/set/pool of PCIs higher layer configured or provided to the UE.
In one example, when/if the set of candidate/new beam RS(s) or RS resource(s) or RS resource (configuration) index(es) provided by the higher layer parameter newBeamResourceSet-r19 for event(s) evaluation(s) comprises one or more NZP CSI-RS resources (e.g., in terms/form of their corresponding resource ID(s)/index(es)) from/in an NZP CSI-RS resource set provided by nzp-CSI-RS-ResourceSet,
   For example, the candidate/new beam RS(s) or RS resource(s) or RS resource (configuration) index(es) in the set provided by the higher layer parameter newBeamResourceSet-r19 could be associated or mapped or specific to a PCI or a PCI index pointing to an entry (and therefore a corresponding PCI) in a list/set/pool of PCIs higher layer provided or configured to the UE.
      In one example, the higher layer parameter(s) nzp-CSI-RS-ResourceSet that provides or configures the NZP CSI-RS resource set that comprises the candidate/new beam RS(s) or RS resource(s) or RS resource (configuration) index(es) in the set provided by the higher layer parameter newBeamResourceSet-r19 could comprise, contain, include, provide or configure the PCI value or the PCI index.
      In another example, the higher layer parameter(s) newBeamResourceSet-r19 that comprises or configures or provides the candidate/new beam RS(s) or RS resource(s) or RS resource (configuration) index(es) could comprise, contain, include, provide or configure the PCI value or the PCI index.
      In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, the set of candidate/new beam RS(s) or RS resource(s) or RS resource (configuration) index(es) provided by the higher layer parameter newBeamResourceSet-r19. In this case, the same higher layer parameter e.g., the CSI report configuration provided by CSI-ReportConfig could comprise, provide, contain, include or configure the PCI value or the PCI index.
   For another example, the UE could be configured or provided by the network, e.g., via higher layer RRC signaling(s)/parameter(s), a set of one or more PCIs or PCI indexes each pointing to an entry (and therefore a corresponding PCI value) in a list/set/pool of PCIs higher layer configured or provided to the UE. For this example, the candidate/new beam RS(s) or RS resource(s) or RS resource (configuration) index(es) in the set provided by the higher layer parameter newBeamResourceSet-r19 could be (one-to-one) associated or mapped or specific to the one or more PCIs or PCI indexes in the set according to e.g., their ordinal positions in their respective sets. For instance, the first entry or the first RS resource or the RS resource with the lowest (or highest) resource ID/index in the candidate/new beam RS(s)/RS resource(s) set could be associated/mapped to the first entry or the first PCI/PCI index or the lowest (or highest) PCI/PCI index in the PCI(s)/PCI index(es) set, the second entry or the second RS resource or the RS resource with the second lowest (or second highest) resource ID/index in the candidate/new beam RS(s)/RS resource(s) set could be associated/mapped to the second entry or the second PCI/PCI index or the second lowest (or second highest) PCI/PCI index in the PCI(s)/PCI index(es) set, and so on, and the last entry or the last RS resource or the RS resource with the highest (or lowest) resource ID/index in the candidate/new beam RS(s)/RS resource(s) set could be associated/mapped to the last entry or the last PCI/PCI index or the highest (or lowest) PCI/PCI index in the PCI(s)/PCI index(es) set.
      In one example, the higher layer parameter(s) nzp-CSI-RS-ResourceSet that provides or configures the NZP CSI-RS resource set that comprises the candidate/new beam RS(s) or RS resource(s) or RS resource (configuration) index(es) in the set provided by the higher layer parameter newBeamResourceSet-r19 could comprise, contain, include, provide or configure the set of the one or more PCIs/PCI indexes.
      In another example, the higher layer parameter(s) newBeamResourceSet-r19 that comprises or configures or provides the candidate/new beam RS(s) or RS resource(s) or RS resource (configuration) index(es) could comprise, contain, include, provide or configure the set of the one or more PCIs/PCI indexes.
      In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, the set of candidate/new beam RS(s) or RS resource(s) or RS resource (configuration) index(es) provided by the higher layer parameter newBeamResourceSet-r19. In this case, the same higher layer parameter e.g., the CSI report configuration provided by CSI-ReportConfig could comprise, provide, contain, include or configure the set of the one or more PCIs/PCI indexes.
In another example, when/if the set of candidate/new beam RS(s) or RS resource(s) or RS resource (configuration) index(es) provided by the higher layer parameter newBeamResourceSet-r19 for event(s) evaluation(s) comprises one or more SSBs (e.g., in terms/form of their corresponding SSB ID(s)/index(es)) from/in a SSB resource set provided by csi-SSB-ResourceSet,
   For example, the candidate/new beam RS(s) or RS resource(s) or RS resource (configuration) index(es) in the set provided by the higher layer parameter newBeamResourceSet-r19 could be associated or mapped or specific to a PCI or a PCI index pointing to an entry (and therefore a corresponding PCI) in a list/set/pool of PCIs higher layer provided or configured to the UE.
      In one example, the higher layer parameter(s) csi-SSB-ResourceSet that provides or configures the SSB resource set that comprises the candidate/new beam RS(s) or RS resource(s) or RS resource (configuration) index(es) in the set provided by the higher layer parameter newBeamResourceSet-r19 could comprise, contain, include, provide or configure the PCI value or the PCI index.
      In another example, the higher layer parameter(s) newBeamResourceSet-r19 that comprises or configures or provides the candidate/new beam RS(s) or RS resource(s) or RS resource (configuration) index(es) could comprise, contain, include, provide or configure the PCI value or the PCI index.
      In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, the set of candidate/new beam RS(s) or RS resource(s) or RS resource (configuration) index(es) provided by the higher layer parameter newBeamResourceSet-r19. In this case, the same higher layer parameter e.g., the CSI report configuration provided by CSI-ReportConfig could comprise, provide, contain, include or configure the PCI value or the PCI index.
   For another example, the UE could be configured or provided by the network, e.g., via higher layer RRC signaling(s)/parameter(s), a set of one or more PCIs or PCI indexes each pointing to an entry (and therefore a corresponding PCI value) in a list/set/pool of PCIs higher layer configured or provided to the UE. For this example, the candidate/new beam RS(s) or RS resource(s) or RS resource (configuration) index(es) in the set provided by the higher layer parameter newBeamResourceSet-r19 could be (one-to-one) associated or mapped or specific to the one or more PCIs or PCI indexes in the set according to e.g., their ordinal positions in their respective sets. For instance, the first entry or the first RS resource or the RS resource with the lowest (or highest) resource ID/index in the candidate/new beam RS(s)/RS resource(s) set could be associated/mapped to the first entry or the first PCI/PCI index or the lowest (or highest) PCI/PCI index in the PCI(s)/PCI index(es) set, the second entry or the second RS resource or the RS resource with the second lowest (or second highest) resource ID/index in the candidate/new beam RS(s)/RS resource(s) set could be associated/mapped to the second entry or the second PCI/PCI index or the second lowest (or second highest) PCI/PCI index in the PCI(s)/PCI index(es) set, and so on, and the last entry or the last RS resource or the RS resource with the highest (or lowest) resource ID/index in the candidate/new beam RS(s)/RS resource(s) set could be associated/mapped to the last entry or the last PCI/PCI index or the highest (or lowest) PCI/PCI index in the PCI(s)/PCI index(es) set.
      In one example, the higher layer parameter(s) csi-SSB-ResourceSet that provides or configures the SSB resource set that comprises the candidate/new beam RS(s) or RS resource(s) or RS resource (configuration) index(es) in the set provided by the higher layer parameter newBeamResourceSet-r19 could comprise, contain, include, provide or configure the set of the one or more PCIs/PCI indexes.
      In another example, the higher layer parameter(s) newBeamResourceSet-r19 that comprises or configures or provides the candidate/new beam RS(s) or RS resource(s) or RS resource (configuration) index(es) could comprise, contain, include, provide or configure the set of the one or more PCIs/PCI indexes.
      In another example, the UE could be provided or configured, in a higher layer parameter e.g., a CSI report configuration provided by CSI-ReportConfig that provides or configures necessary information and/or setting(s) including eventType for the UE-initiated/event-driven beam reporting as specified/defined herein in the present disclosure, the set of candidate/new beam RS(s) or RS resource(s) or RS resource (configuration) index(es) provided by the higher layer parameter newBeamResourceSet-r19. In this case, the same higher layer parameter e.g., the CSI report configuration provided by CSI-ReportConfig could comprise, provide, contain, include or configure the set of the one or more PCIs/PCI indexes.

According to or following those specified or defined herein in the present disclosure, when/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI, and when/if the UE determines the reference signal(s) including the CSI-RS(s) in the indicated joint/DL TCI state (or a/the activated joint/DL TCI state) as the current serving (or activation) beam RS(s) for event evaluation according to or following those specified/defined in Scheme-1, the UE could determine that the reference signal(s) including the CSI-RS(s) could be associated to a PCI if the set of candidate/new beam RS(s) or RS resource(s) or RS resource (configuration) index(es) provided by the higher layer parameter newBeamResourceSet-r19 for event(s) evaluation(s)
comprises one or more NZP CSI-RS resources (e.g., in terms/form of their corresponding resource ID(s)/index(es)) from/in an NZP CSI-RS resource set provided by nzp-CSI-RS-ResourceSet, and/or
is associated or specific or mapped to the (same) PCI according to or following those specified/defined herein in the present disclosure.

According to or following those specified or defined herein in the present disclosure, when/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI, and when/if the UE determines the SSB(s) that is QCL'ed with the reference signal(s) including the CSI-RS(s) in the indicated joint/DL TCI state (or a/the activated joint/DL TCI state) as the current serving (or activation) beam RS(s) for event evaluation according to or following those specified/defined in Scheme-2, the UE could determine that the SSB(s) could be associated to a PCI if the set of candidate/new beam RS(s) or RS resource(s) or RS resource (configuration) index(es) provided by the higher layer parameter newBeamResourceSet-r19 for event(s) evaluation(s)
comprises one or more SSBs (e.g., in terms/form of their corresponding SSB ID(s)/index(es)) from/in an SSB resource set provided by csi-SSB-ResourceSet, and/or
is associated or specific or mapped to the (same) PCI according to or following those specified/defined herein in the present disclosure.

Throughout the present disclosure, a PCI can correspond to a/the serving cell PCI or an additional PCI other than the serving cell PCI. Furthermore, a PCI or PCI index can be provided by a higher layer parameter additionalPCI or additionalPCIIndex or ServingAdditionalPCIIndex, a set of one or more PCIs can be provided by a higher layer parameter servingAdditionalPCIList or SSB-MTC-AdditionalPCI, a list/set/pool of PCIs higher layer configured to the UE can be provided by a higher layer parameter additionalPCI-ToAddModList-r17.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g., Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g., Event-2), and/or
   For example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   For another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   For another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   For another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1

For an activated TCI state—e.g., a joint/DL TCI state, a UE could determine or identify RS(s) or RS resource(s) or RS resource index(es) of/for the activated TCI state—denoted by activation beam RS(s) or RS resource(s) or RS resource index(es)—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

According to or following those specified or defined herein in the present disclosure, when/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI, for evaluating, assessing or determining a given event (e.g., Event-1, Event-2 and/or Event-3 as defined/specified herein in the present disclosure), e.g., when/if the UE is provided or configured by/with a CSI report configuration provided by CSI-ReportConfig that provides or configures necessary information and/or setting(s) for the UE-initiated/event-driven beam reporting as specified/defined herein in the present disclosure configured/provided with eventType set to ‘event-1’, ‘event-2’ or ‘event-3’, the UE could only measure and compare the quality metrics e.g., L1-RSRPs obtained from the current (or activation) beam RS(s) or RS resource(s) and the candidate/new beam RS(s) or RS resource(s)—as specified/defined herein in the present disclosure—that are associated or mapped or specific to the same PCI or PCI index pointing to an entry (and therefore, the corresponding PCI value) in a list/set/pool of PCIs higher layer configured or provided to the UE for event(s) evaluation(s); alternatively, when/if the UE has determined or identified the current (or activation) beam RS(s) or RS resource(s) is associated, mapped or specific to a PCI or PCI index according to or following those specified/defined herein in the present disclosure, the UE could determine or identify a subset of the candidate/new beam RS(s) or RS resource(s)—as specified/defined herein in the present disclosure—that are associated or mapped or specific to the same PCI or PCI index; in this case, the UE could only measure and compare the quality metrics e.g., L1-RSRPs obtained from the current (or activation) beam RS(s) or RS resource(s) and the subset of the candidate/new beam RS(s) or RS resource(s) that are associated or mapped or specific to the same PCI or PCI index pointing to an entry (and therefore, the corresponding PCI value) in a list/set/pool of PCIs higher layer configured or provided to the UE for event(s) evaluation(s).

According to or following those specified or defined herein in the present disclosure, when/if inter-cell beam management or operation is enabled, e.g., when/if the UE is provided or configured with a higher layer parameter interCellBeamManagement and/or set to ‘enabled’, and/or when/if the UE is provided or configured with a higher layer parameter SSB-MTC-AdditionalPCI,
In one example, the UE could report, e.g., in a single reporting instance/CSI report, nrofReportedRS-UEIBR-r19 CRI(s) or SSBRI(s) corresponding to reference signal(s) selected or determined from a set of reference signal(s) provided by the newBeamResourceSet-r19 that comprises at least one reference signal that determines the corresponding event according to or following those specified/defined herein in the present disclosure, wherein each of the candidate/new beam RS(s) or RS resource(s) or RS resource (configuration) index(es) in the set provided by newBeamResourceSet-r19 could be associated or mapped or specific to a same or different PCI value or a same or different PCI index pointing to an entry (hence, a corresponding PCI value) in a list/set/pool of PCIs higher layer configured or provided to the UE according to or following those specified or defined herein in the present disclosure.
In another example, the UE could report, e.g., in a single reporting instance/CSI report, nrofReportedRS-UEIBR-r19 CRI(s) or SSBRI(s) corresponding to reference signal(s) selected or determined from a first set of reference signal(s) provided by the newBeamResourceSet-r19 and a second set of reference signal(s) e.g., a SSB resource set provided by csi-SSB-ResourceSet that comprises at least one reference signal that determines the corresponding event according to or following those specified/defined herein in the present disclosure, wherein the candidate/new beam RS(s) or RS resource(s) or RS resource (configuration) index(es) in the first set provided by newBeamResourceSet-r19 could be associated or mapped or specific to a first PCI value (e.g., the serving cell PCI) or a first PCI index pointing to an entry (hence, a corresponding first PCI value e.g., the serving cell PCI) in a list/set/pool of PCIs higher layer configured or provided to the UE according to or following those specified or defined herein in the present disclosure, and each of the RS(s)/RS resource(s) e.g., SSB(s) in the second set could be associated or mapped or specific to a same or different second PCI value (e.g., an additional PCI other than the serving cell PCI) or a same or different second PCI index pointing to an entry (hence, a corresponding second PCI value e.g., an additional PCI other than the serving cell PCI) in a list/set/pool of PCIs higher layer configured or provided to the UE according to or following those specified or defined herein in the present disclosure. In this case,
   For example, the bitwidth for a reported CRI or SSBRI could be or could correspond to ┌log₂(K₁+K₂)┐, wherein K₁≥1 and K₂≥1 could correspond to a/the number of candidate/new beam RS(s) or RS resource(s) in the first set and a/the number of RS(s) or RS resource(s) e.g., SSB(s) in the second set, respectively.
   For another example, when/if a reported first CRI or SSBRI is selected or determined from the first set of K₁≥1 candidate/new beam RS(s) or RS resource(s) or RS resource (configuration) index(es), the bitwidth for the reported first CRI or SSBRI could be or could correspond to ┌log₂K₁┐, and when/if a reported second CRI or SSBRI is selected or determined from the second set of K₂≥1 RS(s) or RS resource(s) e.g., SSB(s), the bitwidth for the reported second CRI or SSBRI could be or could correspond to ┌log₂K₂┐. In this case, for a reported first CRI or SSBRI, the UE could report, e.g., in the same reporting instance/CSI report, the first PCI or the first PCI index associated, mapped or specific to the reported first CRI or SSBRI, and/or for a reported second CRI or SSBRI, the UE could report, e.g., in the same reporting instance/CSI report, a second PCI or a second PCI index associated, mapped or specific to the reported second CRI or SSBRI.

Furthermore, according to or following those specified herein in the present disclosure, the UE could determine an event specific to a PCI based on or according to quality metrics obtained from the current serving (or activation) beam RS(s)/RS resource(s) and the candidate/new beam RS(s)/RS resource(s) associated, mapped or specific to the (same) PCI, and transmit or send a corresponding PN message/trigger (or equivalently, a corresponding UE-initiated beam report indication (UEIBRI) or a corresponding indication for a UEI-CSI report) in a PUCCH resource configured by a PUCCH resource configuration in a CSI report configuration provided for the UE-initiated/event-driven beam reporting.
In one example, the PUCCH resource configuration and/or the CSI report configuration could be associated with the aforementioned PCI. For instance, higher layer parameter(s) e.g., firstPUCCHResourceConfig-UEIBR-r19 that provides or configures the PUCCH resource configuration and/or CSI-ReportConfig that provides or configures the CSI report configuration could comprise, include, contain, provide or configure the PCI or the PCI index pointing to the PCI.
In another example, the PUCCH resource configured by a PUCCH resource configuration could be associated to multiple (i.e., more than one) CSI report configurations provided for the UE-initiated/event-driven beam reporting each associated or mapped or specific to a PCI/PCI index. In this case, a PUSCH scheduled or indicated by a DCI in response to the transmission of the PN message/trigger or the UEIBRI or the indication for the UEI-CSI report (i.e., of the second UL channel as in Step-3 of Mode A/C) and/or associated to the PUCCH resource (i.e., of the second UL channel as in Step-2 of Mode B) could carry or convey a UEI (beam) report and therefore the corresponding UEI report content(s)/quantity(s) associated or mapped or specific to one of the PCIs/PCI indexes associated or mapped or specific to the multiple CSI report configurations according to or based on values/numbers and/or priorities/priority indexes of the PCIs/PCI indexes in an ascending (or descending) order.
In another example, the UEI beam report and/or the corresponding UEI report content(s)/quantity(s) sent or transmitted on a PUSCH scheduled or indicated by a DCI in response to the transmission of the PN message/trigger or the UEIBRI or the indication for the UEI-CSI report (i.e., of the second UL channel as in Step-3 of Mode A/C) and/or associated to the PUCCH resource (i.e., of the second UL channel as in Step-2 of Mode B) could comprise or include or contain a CSI field indicating the PCI or the PCI index pointing to the PCI.

In this case, the UE could report, e.g., in a single reporting instance/CSI report, nrofReportedRS-UEIBR-r19 CRI(s) or SSBRI(s) corresponding to reference signal(s)—associated or mapped or specific to the aforementioned PCI—selected or determined from a set of reference signal(s) provided by the newBeamResourceSet-r19 that comprises at least one reference signal that determines the corresponding event according to or following those specified/defined herein in the present disclosure. In addition, the UE could report, e.g., in the (same) reporting instance/CSI report, quality metric(s) e.g., differential RSRP(s) for the current serving (or activation) beam RS(s) or RS resource(s) as specified/defined herein in the present disclosure, wherein the current serving (or activation) beam RS(s) or RS resource(s) could be associated or mapped or specific to the aforementioned PCI. Alternatively, for a reported quality metric e.g., a differential RSRP for the current serving (or activation) beam RS(s) or RS resource(s), the UE could report, e.g., in the same reporting instance/CSI report, a PCI or a PCI index associated, mapped or specific to the reported quality metric for the current serving (or activation) beam RS(s) or RS resource(s).

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set of NZP CSI-RS resources provided by NZP-CSI-RS-Resource Set (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g., currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g., currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g., currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network such that the higher layer parameter e.g., currentBeamRStype is set to ‘CSI-RS’.

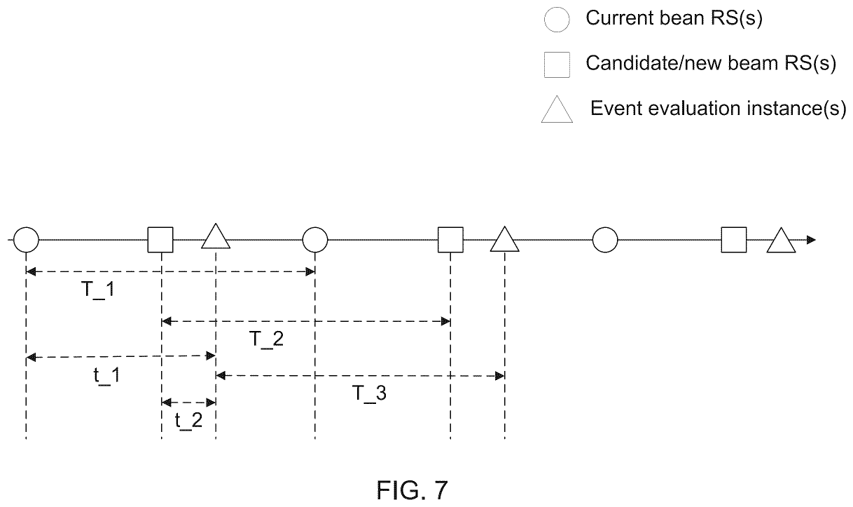

FIGS. 7-9 illustrate examples of timing relations between/of a current serving beam RS(s)/RS resource(s), candidate/new beam RS(s)/RS resource(s), and event evaluation(s)/event evaluation instance(s) according to embodiments of the present disclosure. For example, the timing illustrated in FIGS. 7-9 can be implemented by any of the UEs 111-116 of FIG. 1. These examples are for illustration only and other embodiments can be used without departing from the scope of the present disclosure.

According to or following those specified herein in the present disclosure, an event evaluation or event evaluation instance for determining an event instance (e.g., an Event-1 instance, Event-2 instance or Event-3 instance according to or following those specified herein in the present disclosure) could be associated/specific to one or more RSs/RS resources (e.g., a current beam RS/RS resource and/or one or more candidate/new beam RSs/RS resources in the corresponding resource set) such that: (case-1) the event evaluation/event evaluation instance could collide or overlap or comprise the one or more RSs/RS resources—e.g., the starting symbol/slot of the event evaluation (instance) is the same as/identical to the starting symbol/slot of the one or more RSs/RS resources, and/or the ending symbol/slot of the event evaluation (instance) is the same as/identical to the ending symbol/slot of (last transmission of) the one or more RSs/RS resources, (case-2) the event evaluation/event evaluation instance is after (or before) the one or more RSs/RS resources: in one example, the starting symbol/slot of the event evaluation (instance) could be the same as/identical to the ending (or starting) symbol/slot of the one or more RSs/RS resources or the first symbol/slot after (or before) the ending (or starting) symbol/slot of the one or more RSs/RS resources; in another example, the starting symbol/slot of the event evaluation (instance) could be at least (or at most) X symbol(s)/slot(s) after (or before) or no earlier (or later) than or starting from the ending (or starting) symbol/slot of the one or more RSs/RS resources or the first symbol/slot after (or before) the ending (or starting) symbol/slot of the one or more RSs/RS resources, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Optionally, an event evaluation or event evaluation instance could be of (time) length or duration L symbol(s)/slot(s)/etc., wherein the UE could determine or identify the value of L according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For or within or during an event evaluation or event evaluation instance, the UE could perform (L1) measurement(s) on/of the one or more RSs/RS resources associated/specific to the event evaluation (instance) and obtain/determine/identify the corresponding radio link/beam quality(s) including L1-RSRP(s)/L1-SINR(s)—e.g., when/if the event evaluation (instance) overlaps, collides or comprises the one or more RSs/RS resources as specified/defined herein in the present disclosure, and/or determine or identify occurrence of an event instance—e.g., based on or according to the (latest) L1 measurements of the one or more RSs/RS resources according to or following those specified herein in the present disclosure.

For evaluating, assessing or determining Event-1 or Event-1 instance(s) and/or when/if Event-1 as defined/specified herein in the present disclosure is enabled or provided or configured for the UEI beam reporting, the UE could determine or identify event evaluation(s) or event evaluation instance(s) or time interval(s) between event evaluations/evaluation instances or an event evaluation periodicity or a periodicity of event evaluation for determining Event-1 instance(s) as specified/defined herein in the present disclosure according to or following one or more of the examples set forth below.

In one example, the UE could determine or identify or expect or assume a/the same periodicity between the current serving beam RS(s)/RS resource(s) and the candidate/new beam RS(s)/RS resource(s) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could also be the same/identical. In this case, the event evaluation periodicity for determining Event-1 instance(s) could be the same as/identical to the periodicity of the current serving beam RS(s)/RS resource(s) or the candidate/new beam RS(s)/RS resource(s). Alternatively, the event evaluation periodicity for determining Event-1 instance(s) could be multiple (e.g., K times) of the periodicity of the current serving beam RS(s)/RS resource(s) or the candidate/new beam RS(s)/RS resource(s), wherein the UE could determine or identify the value K according to or based on: (i) a fixed value in system specification(s) and/or per RRC (re-)configuration, e.g., K=1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the UE could determine or identify a time offset between a current serving beam RS/RS resource and a set of candidate/new beam RS(s)/RS resource(s) as the time offset between the current serving beam RS/RS resource and the p-th (e.g., with the p-th lowest/highest resource ID/index, the p-th earliest/latest in time/ordering/ordinal position in the resource set, the p-th transmission/reception and/or etc.) candidate/new beam RS/RS resource (the first (or last) symbol/slot that carries or conveys the current serving beam RS/RS resource could start (or end) a/the time offset earlier (or later) in time than the first (or last) symbol/slot that carries or conveys the p-th candidate/new beam RS/RS resource in the corresponding resource set) among all the candidate/new beam RS(s)/RS resource(s) in the corresponding resource set, wherein the UE could determine or identify the value of p according to or based on: (i) a fixed value in system specification(s) and/or per RRC (re-)configuration, e.g., p=1 or p=P or p=└P/2┘ or p=┌P/2┐ (P represents the total number of candidate/new beam RS(s)/RS resource(s) in the corresponding resource set), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could determine or identify value(s) of the aforementioned time offset based on or according to: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling:
Case-a: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, an event evaluation (instance) for determining Event-1 instance(s) could comprise or correspond to a current serving beam RS/RS resource and candidate/new beam RS(s)/RS resource(s) in the corresponding resource set with zero time offset(s). Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set with zero time offset(s) for determining Event-1 instance(s).
Case-b: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is non-zero (e.g., greater than zero), an event evaluation (instance) for determining Event-1 instance(s) could comprise or correspond to a current serving beam RS/RS resource and candidate/new beam RS(s)/RS resource(s) in the corresponding resource set having/with the lowest/smallest time offset. Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set having/with the lowest/smallest time offset for determining Event-1 instance(s).
Case-c: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is non-zero (e.g., greater than zero), an event evaluation (instance) for determining Event-1 instance(s) could comprise or correspond to a current serving beam RS/RS resource and candidate/new beam RS(s)/RS resource(s) in the corresponding resource set having/with the lowest/smallest time offset among the time offset(s) determined or identified or configured or provided or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) earlier in time than the first (or last) symbol/slot that carries or conveys the current serving beam RS/RS resource. Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set having/with the lowest/smallest time offset—among the time offset(s) determined or identified or provided or configured or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) earlier in time than the first (or last) symbol/slot that carries or conveys the current serving beam RS/RS resource—for determining Event-1 instance(s).
Case-d: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is non-zero (e.g., greater than zero), an event evaluation (instance) for determining Event-1 instance(s) could comprise or correspond to a current serving beam RS/RS resource and candidate/new beam RS(s)/RS resource(s) in the corresponding resource set having/with the lowest/smallest time offset among the time offset(s) determined or identified or provided or configured or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) later in time than the first (or last) symbol/slot that carries or conveys the current serving beam RS/RS resource. Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set having/with the lowest/smallest time offset—among the time offset(s) determined or identified or provided or configured or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) later in time than the first (or last) symbol/slot that carries or conveys the current serving beam RS/RS resource—for determining Event-1 instance(s).

As specified or defined herein in the present disclosure, the event evaluation periodicity for determining Event-1 instance(s) could be the same as/identical to or multiple (e.g., K times) of (a) the periodicity of the current serving beam RS(s)/RS resource(s) and/or (b) the periodicity of the candidate/new beam RS(s)/RS resource(s) in the corresponding resource set(s) depending on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the UE could determine or identify a time offset between an event evaluation (instance) and a set of one or more RSs/RS resources (e.g., a current serving beam RS/RS resource or a set of one or more candidate/new beam RSs/RS resources) as the time offset between the event evaluation (instance) and the p-th (e.g., with the p-th lowest/highest resource ID/index, the p-th earliest/latest in time/ordering/ordinal position in the set, the p-th transmission/reception and/or etc.) RS/RS resource (the first (or last) symbol/slot of the event evaluation instance could start (or end) a/the time offset earlier (or later) in time than the first (or last) symbol/slot that carries or conveys the p-th RS/RS resource in the corresponding set) among all the RS(s)/RS resource(s) in the corresponding set, wherein the UE could determine or identify the value of p according to or based on: (i) a fixed value in system specification(s) and/or per RRC (re-)configuration, e.g., p=1 or p=P or p=└P/2┘ or p=┌P/2┐ (P represents the total number of RS(s)/RS resource(s) in the corresponding set), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could determine or identify value(s) of the aforementioned time offset based on or according to: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

For an event evaluation (instance):
(A): a/the (lowest/smallest) time offset (e.g., higher layer configured/provided by the network subject to a corresponding UE's capability or capability signaling) between the event evaluation (instance) and the current serving beam RS(s)/RS resource(s) could be zero, and a/the (lowest/smallest) time offset (e.g., higher layer configured/provided by the network subject to a corresponding UE's capability or capability signaling) between the event evaluation (instance) and the candidate/new beam RS(s)/RS resource(s) in the corresponding resource set(s) could be non-zero (e.g., greater than zero). In this case, the event evaluation (instance) could be specific/associated to a corresponding current serving beam RS/RS resource. That is, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the current serving beam RS(s)/RS resource(s)—e.g., following those specified or defined in case-1 and/or case-2 by replacing the one or more RSs/RS resources with the current serving beam RS(s)/RS resource(s). For instance, the starting (and/or ending) symbol/slot of the event evaluation (instance) could be the same as/identical to the starting (and/or ending) symbol/slot of the current beam RS/RS resource—denoted by the first starting (and/or first ending) symbol/slot.
(B): a/the (lowest/smallest) time offset (e.g., higher layer configured/provided by the network subject to a corresponding UE's capability or capability signaling) between the event evaluation (instance) and the candidate/new beam RS(s)/RS resource(s) in the corresponding resource set(s) could be zero, and a/the (lowest/smallest) time offset (e.g., higher layer configured/provided by the network subject to a corresponding UE's capability or capability signaling) between the event evaluation (instance) and the current serving beam RS(s)/RS resource(s) could be non-zero (e.g., greater than zero). In this case, the event evaluation (instance) could be specific/associated to the corresponding candidate/new beam RS(s)/RS resource(s) in the corresponding resource set. That is, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the candidate/new beam RS(s)/RS resource(s) in the corresponding resource set—e.g., following those specified or defined in case-1 and/or case-2 by replacing the one or more RSs/RS resources with the candidate/new beam RS(s)/RS resource(s). For instance, the starting symbol/slot of the event evaluation (instance) could be the same as/identical to the starting symbol/slot of the first transmission of the one or more candidate/new beam RSs/RS resources in the corresponding resource set—denoted by the second starting symbol/slot, and the ending symbol/slot of the event evaluation (instance) could be the same as/identical to the ending symbol/slot of the last transmission of the one or more candidate/new beam RSs/RS resources in the corresponding resource set—denoted by the second ending symbol/slot.
(C): a/the (lowest/smallest) time offset (e.g., higher layer configured/provided by the network subject to a corresponding UE's capability or capability signaling) between the event evaluation (instance) and the candidate/new beam RS(s)/RS resource(s) in the corresponding resource set(s) could be zero, and a/the (lowest/smallest) time offset (e.g., higher layer configured/provided by the network subject to a corresponding UE's capability or capability signaling) between the event evaluation (instance) and the current serving beam RS(s)/RS resource(s) could be zero, and/or a/the (lowest/smallest) time offset (e.g., higher layer configured/provided by the network subject to a corresponding UE's capability or capability signaling) between the event evaluation (instance) and a set of the candidate/new beam RS(s)/RS resource(s) in the corresponding resource set(s) and the current serving beam RS(s)/RS resource(s) could be zero. In this case, the event evaluation (instance) could be specific/associated to a corresponding current serving beam RS/RS resource and/or candidate/new beam RS(s)/RS resource(s) in the corresponding resource set. That is, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding current beam RS/RS resource and/or candidate/new beam RS(s)/RS resource(s) in the corresponding resource set—e.g., following those specified or defined in case-1 and/or case-2 by replacing the one or more RSs/RS resources with the corresponding current beam RS/RS resource and/or candidate/new beam RS(s)/RS resource(s). For instance, the starting symbol/slot of the event evaluation (instance) could be the same as/identical to one or more of: (1) the starting symbol/slot of the current beam RS/RS resource—denoted by the first starting symbol/slot, (2) the starting symbol/slot of the first transmission of the one or more candidate/new beam RSs/RS resources in the corresponding resource set—denoted by the second starting symbol/slot, (3) min{the first starting symbol/slot, the second starting symbol/slot}—i.e., which one of them comes earlier in time, and (4) max{the first starting symbol/slot, the second starting symbol/slot}—i.e., which one of them comes later in time, wherein the UE could determine or identify which one or more of (1), (2), (3) and (4) to use or apply for determining the starting symbol/slot of the event evaluation (instance) according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In addition, the ending symbol/slot of the event evaluation (instance) could be the same as/identical to one or more of: (a) the ending symbol/slot of the current beam RS/RS resource—denoted by the first ending symbol/slot, (b) the ending symbol/slot of the last transmission of the one or more candidate/new beam RSs/RS resources in the corresponding resource set—denoted by the second ending symbol/slot, (3) min{the first ending symbol/slot, the second ending symbol/slot}—i.e., which one of them comes earlier in time, and (4) max{the first ending symbol/slot, the second ending symbol/slot}—i.e., which one of them comes later in time, wherein the UE could determine or identify which one or more of (a), (b), (c) and (d) to use or apply for determining the ending symbol/slot of the event evaluation (instance) according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(D): the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding current serving beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of a corresponding current serving beam RS/RS resource or the first symbol/slot after (or before) the ending (or starting) symbol/slot of the corresponding current serving beam RS/RS resource, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(E): the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding candidate/new beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of one or more corresponding candidate/new beam RSs/RS resources in the resource set or the first symbol/slot after (or before) the ending (or starting) symbol/slot of the corresponding candidate/new beam RS(s)/RS resource(s) in the resource set, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(F): when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding current serving beam RS(s)/RS resource(s) and/or candidate/new beam RS(s)/RS resource(s)—e.g., the UE could determine or identify that the starting symbol/slot of an event evaluation (instance) could be at least (or at most) X symbol(s)/slot(s) after (or before) or no earlier (or later) than or starting from (1) the ending (or starting) symbol/slot of a corresponding current serving beam RS/RS resource or (2) the ending (or starting) symbol/slot of one or more corresponding candidate/new beam RSs/RS resources in the resource set according to or based on: (i) fixed rule(s) in system specification(s) and/or per RRC (re-)configuration, e.g., which of (1) or (2) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, or the UE could determine or identify that the starting symbol/slot of an event evaluation (instance) could be at least (or at most) X symbol(s)/slot(s) after (or before) or no earlier (or later) than or starting from (a) the first symbol/slot after (or before) the ending (or starting) symbol/slot of the corresponding current serving beam RS/RS resource or (b) the first symbol/slot after (or before) the ending (or starting) symbol/slot of the corresponding candidate/new beam RS(s)/RS resource(s) in the resource set according to or based on: (i) fixed rule(s) in system specification(s) and/or per RRC (re-)configuration, e.g., which of (a) or (b) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various
UL channels/signals and/or in part of a CSI/beam report and/or UEs capability signaling. ° (G): the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s). In this case, the UE could autonomously determine or decide or choose or select or identify timing relation(s) between (1) the event evaluation instance(s) and (2) the corresponding current serving beam RS(s)/RS resource(s) and/or candidate/new beam RS(s)/RS resource(s), e.g., by the UE's implementation.

The UE could identify or determine event evaluation instances (and therefore, carry out or perform or conduct the corresponding operation(s) according to or following those specified herein in the present disclosure) for determining Event-1 instance(s) based on or according to one or more of (A), (B), (C), (D), (E), (F) and (G) based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. FIG. 7 illustrates a conceptual example characterizing the aforementioned timing relations between/of the current serving beam RS(s)/RS resource(s), candidate/new beam RS(s)/RS resource(s) and event evaluation(s)/event evaluation instance(s). In FIG. 7, T_1, T_2, T_3 are periodicities of current beam RS(s), candidate/new beam RS(s), and event evaluation instance(s), which could be the same/identical. Further, t_1 is the time offset between an event evaluation instance and a corresponding current beam RS, where t_1≥X, and t_2 is the time offset between an event evaluation instance and corresponding candidate/new beam RS(s), where t_2≥X.

In another example, the UE could determine or identify or expect or assume a/the same periodicity between the current serving beam RS(s)/RS resource(s) and the candidate/new beam RS(s)/RS resource(s) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could also be the same/identical. In this case, periodicity of candidate event evaluation(s) or candidate event evaluation instance(s) for determining Event-1 instance(s) could be different from the periodicity of the current serving beam RS(s)/RS resource(s) or the candidate/new beam RS(s)/RS resource(s), wherein when/if a candidate event evaluation instance is determined or identified as an event evaluation instance, the UE could conduct, perform or carry out the corresponding event evaluation(s) procedure(s) for/within the candidate event evaluation instance according to or following those specified herein in the present disclosure for determining Event-1 instance(s); otherwise, the UE would not conduct, perform or carry out any event evaluation(s) procedure(s) for/within the candidate event evaluation instance according to or following those specified herein in the present disclosure for determining Event-1 instance(s). For example, the periodicity of the candidate event evaluation(s) or event evaluation instance(s) could be smaller than (e.g., 1/N times of) the periodicity of the current serving beam RS(s)/RS resource(s) or the candidate/new beam RS(s)/RS resource(s), wherein N>1. For another example, the periodicity of the candidate event evaluation(s) or event evaluation instance(s) could be greater than (e.g., N times of) the periodicity of the current serving beam RS(s)/RS resource(s) or the candidate/new beam RS(s)/RS resource(s), wherein N>1. The UE could determine or identify the periodicity of the candidate event evaluation instance(s) and/or the value of N according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this example, an event evaluation (instance)—i.e., out of the candidate event evaluation instance(s)—for determining Event-1 instance(s) could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d.

For an event evaluation (instance):
(H): the UE could identify or determine event evaluation instances (and therefore, carry out or perform or conduct the corresponding operation(s) according to or following those specified herein in the present disclosure)—out of the candidate event evaluation instance(s)—for determining Event-1 instance(s) based on or according to a/the periodicity of the candidate event evaluation instance(s), their timing relations with respect to the corresponding current serving beam RS(s)/RS resource(s)—e.g., the starting symbol/slot of an event evaluation (instance)—e.g., out of all the candidate event evaluation instance(s)—could be at least (or at most) X symbol(s)/slot(s) after (or before) or no earlier (or later) than or starting from the ending (or starting) symbol/slot of a corresponding current serving beam RS/RS resource or the first symbol/slot after (or before) the ending (or starting) symbol/slot of the corresponding current serving beam RS/RS resource, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance)—e.g., out of all the candidate event evaluation instance(s)—could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to the candidate/new beam RS(s)/RS resource(s) in the corresponding resource set—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(I): the UE could identify or determine event evaluation instances (and therefore, carry out or perform or conduct the corresponding operation(s) according to or following those specified herein in the present disclosure)—out of the candidate event evaluation instance(s)—for determining Event-1 instance(s) based on or according to a/the periodicity of the candidate event evaluation instance(s), their timing relations with respect to the corresponding candidate/new beam RS(s)/RS resource(s)—e.g., the starting symbol/slot of an event evaluation (instance)—e.g., out of all the candidate event evaluation instance(s)—could be at least (or at most) X symbol(s)/slot(s) after (or before) or no earlier (or later) than or starting from the ending (or starting) symbol/slot of one or more corresponding candidate/new beam RSs/RS resources in the resource set or the first symbol/slot after (or before) the ending (or starting) symbol/slot of the corresponding candidate/new beam RS(s)/RS resource(s) in the resource set, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance)—e.g., out of all the candidate event evaluation instance(s)—could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to a current beam RS/RS resource—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(J): when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, the UE could identify or determine event evaluation instances (and therefore, carry out or perform or conduct the corresponding operation(s) according to or following those specified herein in the present disclosure)—out of the candidate event evaluation instance(s)—for determining Event-1 instance(s) based on or according to a/the periodicity of the candidate event evaluation instance(s), their timing relations with respect to the corresponding current serving beam RS(s)/RS resource(s) and/or candidate/new beam RS(s)/RS resource(s)—e.g., the UE could determine or identify that the starting symbol/slot of an event evaluation (instance)—e.g., out of all the candidate event evaluation instance(s)—could be at least (or at most) X symbol(s)/slot(s) after (or before) or no earlier (or later) than or starting from (1) the ending (or starting) symbol/slot of a corresponding current serving beam RS/RS resource or (2) the ending (or starting) symbol/slot of one or more corresponding candidate/new beam RSs/RS resources in the resource set according to or based on: (i) fixed rule(s) in system specification(s) and/or per RRC (re-)configuration, e.g., which of (1) or (2) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, or the UE could determine or identify that the starting symbol/slot of an event evaluation (instance)—e.g., out of all the candidate event evaluation instance(s)—could be at least (or at most) X symbol(s)/slot(s) after (or before) or no earlier (or later) than or starting from (a) the first symbol/slot after (or before) the ending (or starting) symbol/slot of the corresponding current serving beam RS/RS resource or (b) the first symbol/slot after (or before) the ending (or starting) symbol/slot of the corresponding candidate/new beam RS(s)/RS resource(s) in the resource set according to or based on: (i) fixed rule(s) in system specification(s) and/or per RRC (re-)configuration, e.g., which of (a) or (b) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; in this case, the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance)—e.g., out of all the candidate event evaluation instance(s)—could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (K): the UE could identify or determine event evaluation instances (and therefore, carry out or perform or conduct the corresponding operation(s) according to or following those specified herein in the present disclosure)—i.e., out of all the candidate event evaluation instances—for determining Event-1 instance(s) based on or according to a/the periodicity of the candidate event evaluation instance(s), and/or their timing relations with respect to a measurement occasion (MO)—e.g., the starting symbol/slot of an event evaluation (instance)—e.g., out of all the candidate event evaluation instance(s)—could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (L): the UE could identify or determine event evaluation instances (and therefore, carry out or perform or conduct the corresponding operation(s) according to or following those specified herein in the present disclosure)—i.e., out of all the candidate event evaluation instances—for determining Event-1 instance(s) based on or according to a/the periodicity of the candidate event evaluation instance(s), and/or their timing relations with respect to a measurement occasion (MO)—e.g., the starting symbol/slot of an event evaluation (instance)—e.g., out of all the candidate event evaluation instance(s)—could be at least (or at most) X symbol(s)/slot(s) after (or before) or no earlier (or later) than or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of X according to or based on: fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (M): the UE could identify or determine event evaluation instances (and therefore, carry out or perform or conduct the corresponding operation(s) according to or following those specified herein in the present disclosure)—i.e., out of all the candidate event evaluation instances—for determining Event-1 instance(s) based on or according to a/the periodicity of the candidate event evaluation instance(s). In this case, the UE could autonomously determine or decide or choose or select or identify timing relation(s) between (1) the event evaluation instance(s) and (2) the corresponding current serving beam RS(s)/RS resource(s) and/or candidate/new beam RS(s)/RS resource(s), e.g., by/according to/based on the UE's implementation. In this case, each of the candidate event evaluation instances could correspond to an event evaluation instance as specified/defined herein in the present disclosure, or equivalently, the UE could determine or identify each of the candidate event evaluation instances as an event evaluation instance as specified/defined herein in the present disclosure, within which the UE could carry out or perform or conduct the corresponding event evaluation operation(s) for determining Event-1 instance(s) according to or following those specified herein in the present disclosure.

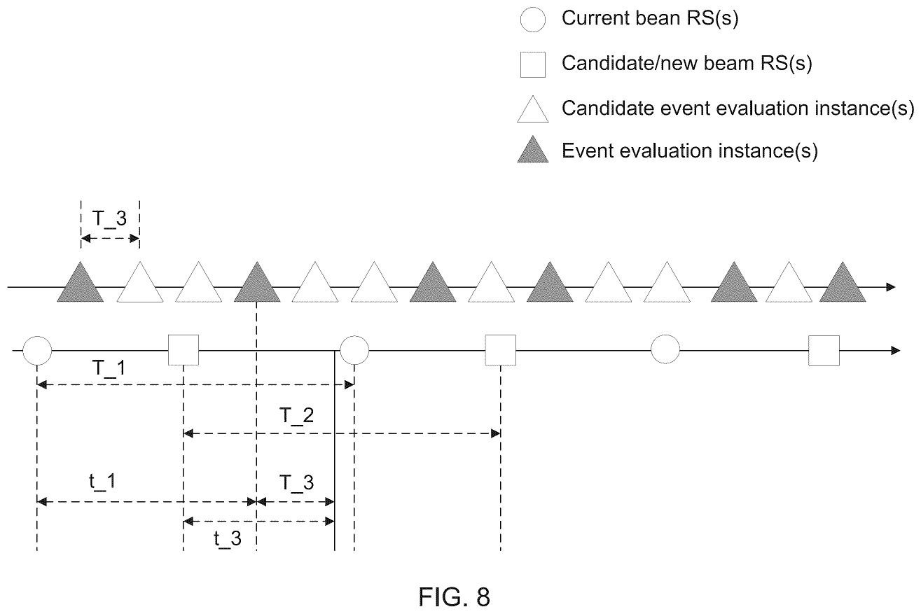

The UE could identify or determine event evaluation instances (and therefore, carry out or perform or conduct the corresponding operation(s) according to or following those specified herein in the present disclosure) for determining Event-1 instance(s) based on or according to one or more of (H), (I), (J), (K) and (L) based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. FIG. 8 illustrates a conceptual example characterizing the aforementioned timing relations between/of the current serving beam RS(s)/RS resource(s), candidate/new beam RS(s)/RS resource(s) and event evaluation(s)/event evaluation instance(s). In FIG. 8, T_1, T_2, T_3 are periodicities of current beam RS(s), candidate/new beam RS(s), and event evaluation instance(s), which could be the same/identical. Further, t_1 is the time offset between an event evaluation instance and a corresponding current beam RS, where t_1≥X, t_2 is the time offset between a reference time instance and a corresponding MO, where t_2≥Z, and t_3 is the time offset between the event evaluation instance and the reference time instance, where t_3≥Y.

In another example, the UE could determine or identify or expect or assume a/the same periodicity between the current serving beam RS(s)/RS resource(s) and the candidate/new beam RS(s)/RS resource(s) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could also be the same/identical. For this example, an event evaluation (instance) for determining an Event-1 instance could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d.

For an event evaluation (instance):
(N): the UE could identify or determine event evaluation instances (and therefore, carry out or perform or conduct the corresponding operation(s) according to or following those specified herein in the present disclosure) for determining Event-1 instance(s) based on or according to their timing relations with respect to the corresponding current serving beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of a corresponding current serving beam RS/RS resource or the first symbol/slot after (or before) the ending (or starting) symbol/slot of the corresponding current serving beam RS/RS resource, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance) could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to the candidate/new beam RS(s)/RS resource(s) in the corresponding resource set—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(O): the UE could identify or determine event evaluation instances (and therefore, carry out or perform or conduct the corresponding operation(s) according to or following those specified herein in the present disclosure) for determining Event-1 instance(s) based on or according to their timing relations with respect to the corresponding candidate/new beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of one or more corresponding candidate/new beam RSs/RS resources in the resource set or the first symbol/slot after (or before) the ending (or starting) symbol/slot of the corresponding candidate/new beam RS(s)/RS resource(s) in the resource set, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance) could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to a current beam RS/RS resource—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(P): when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, the UE could identify or determine event evaluation instances (and therefore, carry out or perform or conduct the corresponding operation(s) according to or following those specified herein in the present disclosure) for determining Event-1 instance(s) based on or according to their timing relations with respect to the corresponding current serving beam RS(s)/RS resource(s) and/or candidate/new beam RS(s)/RS resource(s)—e.g., the UE could determine or identify that the starting symbol/slot of an event evaluation (instance) could be at least (or at most) X symbol(s)/slot(s) after (or before) or no earlier (or later) than or starting from (1) the ending (or starting) symbol/slot of a corresponding current serving beam RS/RS resource or (2) the ending (or starting) symbol/slot of one or more corresponding candidate/new beam RSs/RS resources in the resource set according to or based on: (i) fixed rule(s) in system specification(s) and/or per RRC (re-)configuration, e.g., which of (1) or (2) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, or the UE could determine or identify that the starting symbol/slot of an event evaluation (instance) could be at least (or at most) X symbol(s)/slot(s) after (or before) or no earlier (or later) than or starting from (a) the first symbol/slot after (or before) the ending (or starting) symbol/slot of the corresponding current serving beam RS/RS resource or (b) the first symbol/slot after (or before) the ending (or starting) symbol/slot of the corresponding candidate/new beam RS(s)/RS resource(s) in the resource set according to or based on: (i) fixed rule(s) in system specification(s) and/or per RRC (re-)configuration, e.g., which of (a) or (b) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; in this case, the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance) could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Q): the UE could identify or determine event evaluation instances (and therefore, carry out or perform or conduct the corresponding operation(s) according to or following those specified herein in the present disclosure) for determining Event-1 instance(s) based on or according to their timing relations with respect to a measurement occasion (MO)—e.g., the starting symbol/slot of an event evaluation (instance) could be at least Y symbol(s)/slot(s) before or prior to or earlier than a reference time instance e.g., a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (R): the UE could identify or determine event evaluation instances (and therefore, carry out or perform or conduct the corresponding operation(s) according to or following those specified herein in the present disclosure) for determining Event-1 instance(s) based on or according to their timing relations with respect to a measurement occasion (MO)—e.g., the starting symbol/slot of an event evaluation (instance) could be at least (or at most) X symbol(s)/slot(s) after (or before) or no earlier (or later) than or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of X according to or based on: fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

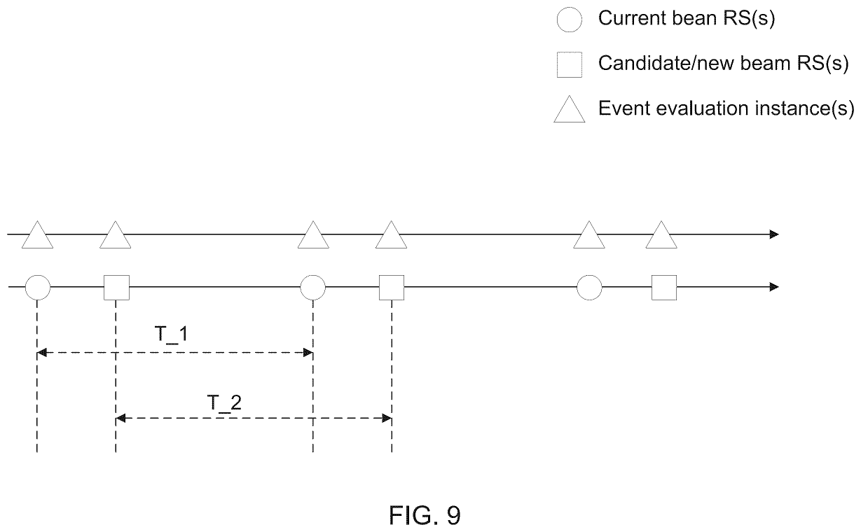

The UE could identify or determine event evaluation instances (and therefore, carry out or perform or conduct the corresponding operation(s) according to or following those specified herein in the present disclosure) for determining Event-1 instance(s) based on or according to one or more of (N), (O), (P), (Q) and (R) based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. FIG. 9 illustrates a conceptual example characterizing the aforementioned timing relations between/of the current serving beam RS(s)/RS resource(s), candidate/new beam RS(s)/RS resource(s) and event evaluation(s)/event evaluation instance(s).

In another example, the UE could determine or identify or expect or assume different periodicities between the current serving beam RS(s)/RS resource(s) and the candidate/new beam RS(s)/RS resource(s) such that the UE could determine or identify a first periodicity for/of the current beam RS(s)/RS resource(s) and/or a second periodicity of/for the candidate/new beam RS(s)/RS resource(s) in the corresponding resource set (i.e., the first periodicity is different from the second periodicity) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could be the same/identical. The UE could determine or identify periodicity of (candidate) event evaluation(s) or (candidate) event evaluation instance(s)—denoted by a reference periodicity—as or according to or same as/identical to one or more of:
The periodicity of the current serving beam RS(s)/RS resource(s)—denoted by a first periodicity
The periodicity of the candidate/new beam RS(s)/RS resource(s)—denoted by a second periodicity
min{the first periodicity, the second periodicity}
max{the first periodicity, the second periodicity}
max{x ms, min{the first periodicity, the second periodicity}}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
Fixed value(s)/rule(s) in system specification(s) and/or per RRC (re-)configuration
Network's configuration(s)/indication(s) via higher layer RRC signaling(s)/parameter(s) and/or MAC CE command(s) and/or dynamic DCI based L1 signaling(s) according to or based on a corresponding UE's capability or capability signaling
UE's autonomous determination/selection, which could be further sent to the network via various UL channels/signals and/or in part of a CSI/beam report and/or UE's capability signaling

For the aforementioned example, an event evaluation (instance) for determining an Event-1 instance could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d. Furthermore, the UE could identify or determine event evaluation instances (and therefore, carry out or perform or conduct the corresponding operation(s) according to or following those specified herein in the present disclosure) for determining Event-1 instance(s) according to or based on the periodicity of the (candidate) event evaluation instance(s), their timing relations with respect to the corresponding current serving beam RS(s)/RS resource(s), and/or their timing relations with respect to the corresponding candidate/new beam RS(s)/RS resource(s) in the resource set, and/or their timing relations with respect to MO(s) with each MO comprising or corresponding to a current serving beam RS/RS resource and/or candidate/new beam RS(s)/RS resource(s), according to or following those specified herein in the present disclosure—e.g., following or according to those specified in the above examples.

In another example, the UE could determine or identify or expect or assume different periodicities between the current serving beam RS(s)/RS resource(s) and the candidate/new beam RS(s)/RS resource(s) such that the UE could determine or identify a first periodicity for/of the current beam RS(s)/RS resource(s) and/or a second periodicity of/for the candidate/new beam RS(s)/RS resource(s) in the corresponding resource set (i.e., the first periodicity is different from the second periodicity) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could be the same/identical. For this example, an event evaluation (instance) for determining an Event-1 instance could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d. Furthermore, the UE could identify or determine event evaluation instances (and therefore, carry out or perform or conduct the corresponding operation(s) according to or following those specified herein in the present disclosure) for determining Event-1 instance(s) according to or based on their timing relations with respect to the corresponding current serving beam RS(s)/RS resource(s), and/or their timing relations with respect to the corresponding candidate/new beam RS(s)/RS resource(s) in the resource set, and/or their timing relations with respect to MO(s) with each MO comprising or corresponding to a current serving beam RS/RS resource and/or candidate/new beam RS(s)/RS resource(s), according to or following those specified herein in the present disclosure—e.g., following or according to those specified in the above examples.

For evaluating, assessing or determining Event-2 or Event-2 instance(s) and/or when/if Event-2 as defined/specified herein in the present disclosure is enabled or provided or configured for the UEI beam reporting, the UE could determine or identify event evaluation(s) or event evaluation instance(s) or time interval(s) between event evaluations/evaluation instances or an event evaluation periodicity or a periodicity of event evaluation for determining Event-2 instance(s) as specified/defined herein in the present disclosure according to or following those specified/defined herein in the present disclosure—e.g., following or according to those specified in the above examples for determining or identifying event evaluation(s) or event evaluation instance(s) or time interval(s) between event evaluations/evaluation instances or an event evaluation periodicity or a periodicity of event evaluation for determining Event-1 instance(s). The measurement RS(s)/RS resource(s) of current serving beam RS(s)/RS resource(s) and/or candidate/new beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-1 instance(s) as specified/described in the above examples can be replaced by/with measurement RS(s)/RS resource(s) of only current serving beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-2 instance(s). That is, means of determining or identifying event evaluation(s) or event evaluation instance(s) or time interval(s) between event evaluations/evaluation instances or an event evaluation periodicity or a periodicity of event evaluation for determining Event-1 instance(s) can be extended/applied to determine or identify event evaluation(s) or event evaluation instance(s) or time interval(s) between event evaluations/evaluation instances or an event evaluation periodicity or a periodicity of event evaluation for determining Event-2 instance(s) by considering, updating or modifying a MO in the above examples that comprise or correspond to current beam RS(s)/RS resource(s) and/or candidate/new beam RS(s)/RS resource(s) in the corresponding resource set to comprise or correspond to only the current serving beam RS(s)/RS resource(s).

For evaluating, assessing or determining Event-3 or Event-3 instance(s) and/or when/if Event-3 as defined/specified herein in the present disclosure is enabled or provided or configured for the UEI beam reporting, the UE could determine or identify event evaluation(s) or event evaluation instance(s) or time interval(s) between event evaluations/evaluation instances or an event evaluation periodicity or a periodicity of event evaluation for determining Event-3 instance(s) as specified/defined herein in the present disclosure according to or following those specified/defined herein in the present disclosure—e.g., following or according to those specified in the above examples for determining or identifying event evaluation(s) or event evaluation instance(s) or time interval(s) between event evaluations/evaluation instances or an event evaluation periodicity or a periodicity of event evaluation for determining Event-1 instance(s).

In one example, the periodicity of all the activation beam RS(s)/RS resource(s) in the corresponding activated TCI state(s), e.g., indicated/provided by/in a (unified) TCI state(s) activation/deactivation MAC CE, could be the same/identical. For this example, the UE could determine or identify or assume or expect:
a/the same periodicity between the candidate/new beam RS(s)/RS resource(s) in the corresponding resource set and the activation beam RS(s)/RS resource(s) in the corresponding activated TCI state(s), or
different periodicities between the candidate/new beam RS(s)/RS resource(s) in the corresponding resource set and the activation beam RS(s)/RS resource(s) in the corresponding activated TCI state(s) such that the UE could determine or identify a first periodicity for/of the candidate/new beam RS(s)/RS resource(s) and/or a second periodicity of/for the activation beam RS(s)/RS resource(s) (i.e., the first periodicity is different from the second periodicity),
   according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could also be the same/identical.

In another example, each of the activation beam RS(s)/RS resource(s) in the corresponding activated TCI state(s), e.g., indicated/provided by/in a (unified) TCI state(s) activation/deactivation MAC CE, could have a different periodicity (e.g., from other activate beam RS(s)/RS resource(s)). For this example, the UE could determine or identify or assume or expect:
a/the same periodicity between the candidate/new beam RS(s)/RS resource(s) in the corresponding resource set and the activation beam RS(s)/RS resource(s) in the corresponding activated TCI state(s) that has the shortest/smallest periodicity among all the activation beam RS(s)/RS resource(s) in the corresponding activated TCI state(s), e.g., indicated/provided by/in the (unified) TCI state(s) activation/deactivation MAC CE, or
a/the same periodicity between the candidate/new beam RS(s)/RS resource(s) in the corresponding resource set and the activation beam RS(s)/RS resource(s) in the corresponding activated TCI state(s) that has the longest/largest periodicity among all the activation beam RS(s)/RS resource(s) in the corresponding activated TCI state(s), e.g., indicated/provided by/in the (unified) TCI state(s) activation/deactivation MAC CE, or
a/the same periodicity between the candidate/new beam RS(s)/RS resource(s) in the corresponding resource set and the q-th (e.g., with the q-th lowest/highest resource ID/index, the q-th earliest/latest in time/ordering/ordinal position among all the activation beam RS(s)/RS resource(s), the q-th transmission/reception and/or etc.) activation beam RS(s)/RS resource(s) in the corresponding activated TCI state(s) among all the activation beam RS(s)/RS resource(s) in the corresponding activated TCI state(s), e.g., indicated/provided by/in the (unified) TCI state(s) activation/deactivation MAC CE, or
a/the same periodicity between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among all the activated TCI state(s) and/or etc.) activated TCI state(s) among all the activated TCI state(s), e.g., indicated/provided by/in the (unified) TCI state(s) activation/deactivation MAC CE, or
different periodicities between the candidate/new beam RS(s)/RS resource(s) in the corresponding resource set and the activation beam RS(s)/RS resource(s) in the corresponding activated TCI state(s) that has the shortest/smallest periodicity among all the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the shortest/smallest periodicity for/of the activation beam RS(s)/RS resource(s) among all the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
different periodicities between the candidate/new beam RS(s)/RS resource(s) in the corresponding resource set and the activation beam RS(s)/RS resource(s) in the corresponding activated TCI state(s) that has the longest/largest periodicity among all the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the longest/largest periodicity for/of the activation beam RS(s)/RS resource(s) among all the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
different periodicities between the candidate/new beam RS(s)/RS resource(s) in the corresponding resource set and the q-th (e.g., with the q-th lowest/highest resource ID/index, the q-th earliest/latest in time/ordering/ordinal position among all the activation beam RS(s)/RS resource(s), the q-th transmission/reception and/or etc.) activation beam RS(s)/RS resource(s) in the corresponding activated TCI state(s) among all the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity for/of the q-th activation beam RS(s)/RS resource(s) among all the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
different periodicities between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among all the activated TCI state(s) and/or etc.) activated TCI state(s) among all the activated TCI state(s), e.g., indicated/provided by/in the (unified) TCI state(s) activation/deactivation MAC CE such that such that the UE could determine or identify a first periodicity for/of the candidate/new beam RS(s)/RS resource(s) in the corresponding resource set and/or a second periodicity for/of the activation beam RS(s)/RS resource(s) in the q-th activated TCI state(s) among all the activated TCI state(s), e.g., indicated/provided by/in the (unified) TCI state(s) activation/deactivation MAC CE (i.e., the first periodicity is different from the second periodicity),
   according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could be the same/identical. The UE could determine or identify the value of q (if any) according to or based on: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

In another example, one or more of the activation beam RS(s)/RS resource(s) in the corresponding activated TCI state(s), e.g., indicated/provided by/in a (unified) TCI state(s) activation/deactivation MAC CE, could have a same/identical periodicity, and one or more of the activation beam RS(s)/RS resource(s) in the corresponding activated TCI state(s), e.g., indicated/provided by/in the (unified) TCI state(s) activation/deactivation MAC CE, could have different periodicities from each other. For this example, the UE could determine or identify or assume or expect:
a/the same periodicity between the candidate/new beam RS(s)/RS resource(s) in the corresponding resource set and the activation beam RS(s)/RS resource(s) in the corresponding activated TCI state(s) that has the shortest/smallest periodicity among all the activation beam RS(s)/RS resource(s) in the corresponding activated TCI state(s), e.g., indicated/provided by/in the (unified) TCI state(s) activation/deactivation MAC CE, or
a/the same periodicity between the candidate/new beam RS(s)/RS resource(s) in the corresponding resource set and the activation beam RS(s)/RS resource(s) in the corresponding activated TCI state(s) that has the longest/largest periodicity among all the activation beam RS(s)/RS resource(s) in the corresponding activated TCI state(s), e.g., indicated/provided by/in the (unified) TCI state(s) activation/deactivation MAC CE, or
a/the same periodicity between the candidate/new beam RS(s)/RS resource(s) in the corresponding resource set and the q-th (e.g., with the q-th lowest/highest resource ID/index, the q-th earliest/latest in time/ordering/ordinal position among all the activation beam RS(s)/RS resource(s), the q-th transmission/reception and/or etc.) activation beam RS(s)/RS resource(s) in the corresponding activated TCI state(s) among all the activation beam RS(s)/RS resource(s) in the corresponding activated TCI state(s), e.g., indicated/provided by/in the (unified) TCI state(s) activation/deactivation MAC CE,
a/the same periodicity between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among all the activated TCI state(s) and/or etc.) activated TCI state(s) among all the activated TCI state(s), e.g., indicated/provided by/in the (unified) TCI state(s) activation/deactivation MAC CE
different periodicities between the candidate/new beam RS(s)/RS resource(s) in the corresponding resource set and the activation beam RS(s)/RS resource(s) in the corresponding activated TCI state(s) that has the shortest/smallest periodicity among all the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the shortest/smallest periodicity for/of the activation beam RS(s)/RS resource(s) among all the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
different periodicities between the candidate/new beam RS(s)/RS resource(s) in the corresponding resource set and the activation beam RS(s)/RS resource(s) in the corresponding activated TCI state(s) that has the longest/largest periodicity among all the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the longest/largest periodicity for/of the activation beam RS(s)/RS resource(s) among all the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
different periodicities between the candidate/new beam RS(s)/RS resource(s) in the corresponding resource set and the q-th (e.g., with the q-th lowest/highest resource ID/index, the q-th earliest/latest in time/ordering/ordinal position among all the activation beam RS(s)/RS resource(s), the q-th transmission/reception and/or etc.) activation beam RS(s)/RS resource(s) in the corresponding activated TCI state(s) among all the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity for/of the q-th activation beam RS(s)/RS resource(s) among all the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
different periodicities between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among all the activated TCI state(s) and/or etc.) activated TCI state(s) among all the activated TCI state(s), e.g., indicated/provided by/in the (unified) TCI state(s) activation/deactivation MAC CE such that such that the UE could determine or identify a first periodicity for/of the candidate/new beam RS(s)/RS resource(s) in the corresponding resource set and/or a second periodicity for/of the activation beam RS(s)/RS resource(s) in the q-th activated TCI state(s) among all the activated TCI state(s), e.g., indicated/provided by/in the (unified) TCI state(s) activation/deactivation MAC CE (i.e., the first periodicity is different from the second periodicity),
   according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of all the candidate/new beam RS(s)/RS resource(s) in the corresponding candidate/new beam RS(s)/RS resource(s) set could be the same/identical. The UE could determine or identify the value of q (if any) according to or based on: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The UE could determine or identify which of the one or more above examples, specified/described herein in the present disclosure, to use or apply to determine or identify the timing relations between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE, based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
For example, when/if the UE-initiated beam reporting is configured or enabled by the network, e.g., when/if a higher layer parameter ueInitiatedBeamReporting is provided or configured in higher layer parameter(s)/signaling(s) that provides or configures necessary information and/or setting(s) for the UE-initiated beam reporting and/or is set to ‘enabled’, and/or when/if the Event-3 is (higher layer) configured or enabled by the network, the UE could follow those specified in the above examples to determine the timing relations between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE; otherwise, the UE could follow those specified in the above examples to determine the timing relations, and/or the UE could expect or assume that there is no timing restriction(s), between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE.
For another example, when/if the number of activated TCI state(s) provided/indicated in/by a/the (unified) TCI state(s) activation/deactivation MAC CE is smaller or lower than or equal to a threshold/number/quantity, the UE could follow those specified in the above examples to determine the timing relations between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE; otherwise, i.e., when/if the number of activated TCI state(s) provided/indicated in/by a/the (unified) TCI state(s) activation/deactivation MAC CE is larger or greater than or equal to the threshold/number/quantity the UE could follow those specified in the above examples to determine the timing relations, and/or the UE could expect or assume that there is no timing restriction(s), between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE, wherein the UE could identify or determine value(s) of the threshold/number/quantity based on or according to: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The UE could determine or identify a periodicity (if any) of the event evaluation(s) or event evaluation instance(s) for determining Event-3 instance(s) as one or more of:
Periodicity of the current (serving) beam RS(s)/RS resource(s)—denoted by a first periodicity
A reference periodicity of the activation beam RS(s)/RS resource(s) in the corresponding activated TCI state(s), e.g., provided/indicated in a (unified) TCI state(s) activation/deactivation MAC CE—denoted by a second periodicity
min{the first periodicity, the second periodicity}
max{the first periodicity, the second periodicity}
max{x ms, min{the first periodicity, the second periodicity}}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling based on or according to: (i) fixed rule(s)/value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, wherein the UE could determine or identify the reference periodicity of the activation beam RS(s)/RS resource(s)—i.e., the second periodicity—as one or more of:
   Periodicity of the activation beam RS(s)/RS resource(s), e.g., assuming that the periodicity of all the activation beam RS(s)/RS resource(s), e.g., in the corresponding activated TCI state(s) provided/indicated in a/the (unified) TCI state(s) activation/deactivation MAC CE, could be the same/identical
   The shortest/smallest periodicity among all the activation beam RS(s)/RS resource(s) in the corresponding activated TCI state(s), e.g., indicated/provided by/in the (unified) TCI state(s) activation/deactivation MAC CE
   The longest/largest periodicity among all the activation beam RS(s)/RS resource(s) in the corresponding activated TCI state(s), e.g., indicated/provided by/in the (unified) TCI state(s) activation/deactivation MAC CE

For these examples, an event evaluation (instance) for determining an Event-3 instance could comprise or correspond to a current serving beam RS/RS resource and/or activation beam RS(s)/RS resource(s) in the corresponding activated TCI state(s), e.g., provided/indicated in a/the (unified) TCI state(s) activation/deactivation MAC CE, wherein the UE could determine or identify the timing relations between the current serving beam RS/RS resource and the activation beam RS(s)/RS resource(s) according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or activation beam RS(s)/RS resource(s) in the corresponding activated TCI state(s) e.g., provided/indicated in a/the (unified) TCI state(s) activation/deactivation MAC CE, wherein the UE could determine or identify the timing relations between the current serving beam RS/RS resource and the corresponding activation beam RS(s)/RS resource(s) according to or following those specified/defined in one or more of Case-a, Case-b, Case-c and Case-d. The measurement RS(s)/RS resource(s) of current serving beam RS(s)/RS resource(s) and/or candidate/new beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-1 instance(s) as specified/described in the above examples can be replaced by/with measurement RS(s)/RS resource(s) of current serving beam RS(s)/RS resource(s) and/or activation beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-3 instance(s). That is, means of determining or identifying event evaluation(s) or event evaluation instance(s) or time interval(s) between event evaluations/evaluation instances or an event evaluation periodicity or a periodicity of event evaluation for determining Event-1 instance(s) can be extended/applied to determine or identify event evaluation(s) or event evaluation instance(s) or time interval(s) between event evaluations/evaluation instances or an event evaluation periodicity or a periodicity of event evaluation for determining Event-3 instance(s) by considering, updating or modifying a MO in the above examples that comprises or corresponds to current beam RS(s)/RS resource(s) and/or candidate/new beam RS(s)/RS resource(s) in the corresponding resource set to comprise or correspond to the current serving beam RS(s)/RS resource(s) and/or activation beam RS(s)/RS resource(s).

Throughout the present disclosure, a starting symbol/slot could correspond to or could be equivalent to a first (or 1^{st}) symbol/slot (vice versa), an ending symbol/slot could correspond to or could be equivalent to a last symbol/slot (vice versa), a time offset could correspond to or could be equivalent to a time gap (vice versa). Furthermore, throughout the present disclosure, when/if a time offset between an event evaluation (instance) and one or more measurement RSs/RS resources (e.g., current serving beam RS(s)/RS resource(s), candidate/new beam RS(s)/RS resource(s) and/or activation beam RS(s)/RS resource(s)) is non-zero (e.g., greater than zero), the event evaluation (instance) and the one or more measurement RSs/RS resources would not overlap in time-domain.

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting:
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used.
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value msl corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Note that throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.

Further for the above case/setting:
Step 2 (cont.): the (downlink/uplink) DCI in response to the PN message/trigger could further comprise one or more of the following components:
   Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k 1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel

Note that throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.

Further for the above case/setting:
Step 2 (cont.): the (downlink/uplink) DCI in response to the PN message/trigger could further comprise one or more of the following components:
   Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.

Further for the above case/setting:
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

The (downlink/uplink) DCI (in Step-2 above) in response to the transmission of the PN message/trigger in Step-1 above could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting:
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Confg, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used.
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting:
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used.
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k 1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Note that throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.

Further, for the above case/setting:
Step 2 (cont.): the (downlink/uplink) DCI in response to the PN message/trigger could comprise one or more of the following components:
   Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel ki slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, ki, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel

Note that throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.

Further, for the above case/setting:
Step 2 (cont.): the (downlink/uplink) DCI in response to the PN message/trigger could comprise one or more of the following components:
   Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.

Further, for the above case/setting:
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.

For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.

For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is ql (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.

For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this example, regardless of how/when the periodic/semi-persistent PUCCH resource(s) and/or the PUSCH resource(s) such as CG PUSCH of Type1 and/or Type2 is (pre-)configured by the network for transmitting or sending the UEI report content(s)/quantity(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.

For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2 above) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of: {Mode A}, {Mode B}, {Mode C}, {Mode A, Mode B}, {Mode A, Mode C}, and/or {Mode B, Mode C}.

According to or following those specified herein in the present disclosure, for Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.

For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.

For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure:
When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window,
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1 within the time window,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window.

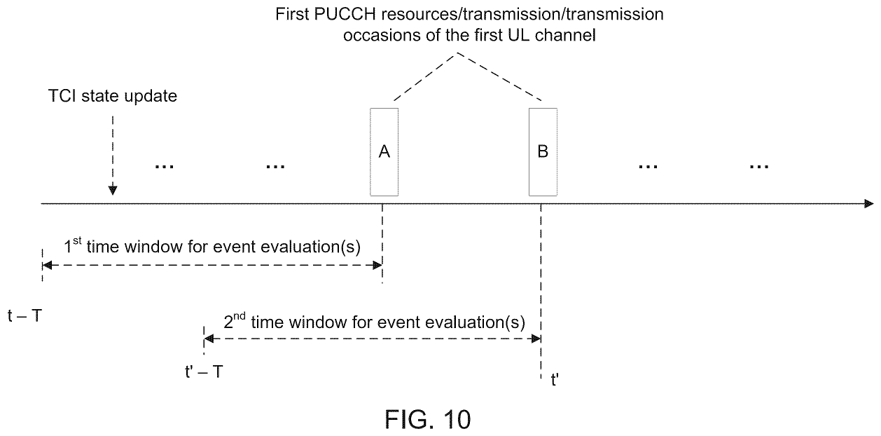

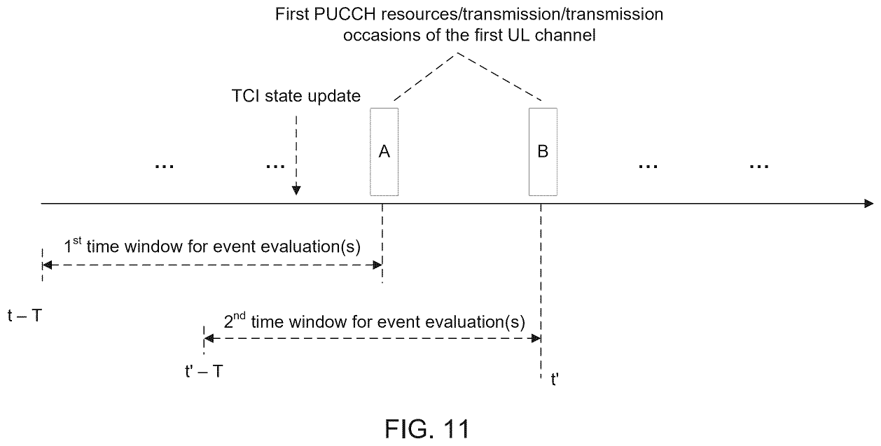

FIGS. 10-11 illustrate examples of PUCCH transmission procedures in relation to TCI state updates according to embodiments of the present disclosure. For example, the PUCCH transmission procedures can be implemented by any of the UEs 111-116 of FIG. 1. These examples are for illustration only and other embodiments can be used without departing from the scope of the present disclosure.

As illustrated in FIGS. 10-11, after the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. More particularly, FIG. 10 illustrates a TCI state update within the 1^{st} time window, and accordingly, PUCCH A is not transmitted. Further, FIG. 10 illustrates no TCI state update within the 2^{nd} time window, and accordingly, PUCCH B can be transmitted, if event conditions are satisfied. FIG. 11, alternatively illustrates a TCI state update within the 1^{st} and 2^{nd} time windows, and accordingly, both PUCCH A and PUCCH B are not transmitted.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window,
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window,
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1 within the time window,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied: The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window,
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window.
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1 within the time window,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Furthermore, the reference beam RS or RS resource could be derived from an activated TCI state with the Q-th best beam quality e.g., L1-RSRP among all the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality).
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality).

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window,
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window,
   the UE could transmit or trigger or initiate a transmission of the PN message/trigger over/on/via/in the PUCCH resource or transmission or transmission occasion of the first UL channel. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. Furthermore, the reference beam RS or RS resource could be derived from an activated TCI state with the Q-th best beam quality e.g., L1-RSRP among all the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality).
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality).

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T−T_proc (e.g., in form of a slot or a symbol, i.e., slot or symbol t−T−T_proc or the (t−T−T_proc)-th slot or symbol) and ending at time t−T_proc is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window,
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window,
The UE does not receive a (unified) TCI state(s) activation/deactivation MAC CE within the time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure,
The UE does not receive any form/format of a beam failure recover response (BFRR) within the time window,
The UE or higher layer(s) of the UE does not start (or starts) a prohibit timer as defined/specified herein in the present disclosure within the time window, and/or the prohibit timer expires (or does not expire) within the time window,
For Mode-A/Mode-B, the UE does not receive a DCI in Step-2 in response to the transmission of the PN message/trigger in Step-1 within the time window,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window,
The UE does not receive triggering of aperiodic or semi-persistent CSI measurement and/or reporting (e.g., via a CSI request field in a triggering DCI) within the time window, and
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Here, T_proc could be in slot, symbol, etc., which could represent processing time of PUCCH transmission(s) of the first UL channel including UCI bit(s) preparation and etc. The UE could determine or identify value(s) of T_proc according to or based on one or more of: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. When/if the UE could not determine or identify or declare an/the event within a first time window starting from time t−T−T_proc and ending at time t−T_proc according to or following those specified herein in the present disclosure: for example, when/if the UE could not identify or determine, within the first time window starting from time t−T−T_proc and ending at time t−T_proc, any candidate/new beam RS(s) or RS resource(s) that satisfies or achieves the event condition(s)—e.g., to satisfy the event condition(s) for a candidate/new beam RS or RS resource, the number/counting of event instance(s) within the first time window should be greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the first time window,
The UE receives a TCI state update within the first time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window.
The UE does not receive a (unified) TCI state(s) activation/deactivation MAC CE within the first time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure,
The UE does not receive any form/format of a beam failure recover response (BFRR) within the first time window,
The UE or higher layer(s) of the UE does not start (or starts) a prohibit timer as defined/specified herein in the present disclosure within the first time window, and/or the prohibit timer expires (or does not expire) within the first time window,
For Mode-A/Mode-B, the UE does not receive a DCI in Step-2 in response to the transmission of the PN message/trigger in Step-1 within the first time window,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window.
The UE does not receive triggering of aperiodic or semi-persistent CSI measurement and/or reporting (e.g., via a CSI request field in a triggering DCI) within the first time window, and
The UE does not receive activation of semi-persistent CSI measurement and/or reporting (e.g., via SP CSI measurement and/or reporting activation MAC CE(s)) within the first time window;
   and for another example, when/if one or more of the following conditions are achieved or satisfied:
The UE receives a TCI state update within the first time window,
The UE receives a TCI state update within the first time window, and the (measured) current beam RS/RS resource associated/specific to or determined/identified based on or according to the TCI state update or updated TCI state according to or following those specified herein in the present disclosure is updated/changed in contrast to or different from the previous one,
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window,
The UE receives a (unified) TCI state(s) activation/deactivation MAC CE within the first time window,
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window,
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure,
The UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure,
The UE receives a beam failure recover response (BFRR) within the first time window,
The UE or higher layer(s) of the UE starts (or does not start) a prohibit timer as defined/specified herein in the present disclosure within the first time window, and/or the prohibit timer does not expire (or expires) within the first time window,
For Mode-A/Mode-B, the UE receives a DCI in Step-2 in response to the transmission of the PN message/trigger in Step-1 within the first time window,
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window,
The UE receives triggering of aperiodic or semi-persistent CSI measurement and/or reporting (e.g., via a CSI request field in a triggering DCI) within the first time window, and
The UE receives activation of semi-persistent CSI measurement and/or reporting (e.g., via SP CSI measurement and/or reporting activation MAC CE(s)) within the first time window, the UE could then determine or identify or declare an/the event when/if the number/counting of event instance(s) within a second time window starting from time t−T−T_proc−t_offset (e.g., in form of a slot or a symbol, i.e., slot or symbol t−T−T_proc−t_offset or the (t−T−T_proc−t_offset)-th slot or symbol) and ending at time t−T_proc−t_offset is greater than or equal to a value/number M (e.g., higher layer configured) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the second time window,
The UE receives a TCI state update within the second time window, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the second time window,
The UE does not receive a (unified) TCI state(s) activation/deactivation MAC CE within the second time window,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the second time window,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the second time window, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the second time window, wherein the UE could determine or identify the value of m according to or following those specified herein in the present disclosure,
The UE does not receive any form/format of a beam failure recover response (BFRR) within the second time window,
The UE or higher layer(s) of the UE does not start (or starts) a prohibit timer as defined/specified herein in the present disclosure within the second time window, and/or the prohibit timer expires (or does not expire) within the second time window,
For Mode-A/Mode-B, the UE does not receive a DCI in Step-2 in response to the transmission of the PN message/trigger in Step-1 within the second time window,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the second time window,
The UE does not receive triggering of aperiodic or semi-persistent CSI measurement and/or reporting (e.g., via a CSI request field in a triggering DCI) within the second time window,
The UE does not receive activation of semi-persistent CSI measurement and/or reporting (e.g., via SP CSI measurement and/or reporting activation MAC CE(s)) within the second time window.

After the determination or identification or declaration of an/the event according to the second time window, the UE could transmit or trigger or initiate a transmission of the PN message/trigger over/on/via/in the PUCCH resource or transmission or transmission occasion of the first UL channel at time t. The UE could determine or identify value(s) of t_offset (e.g., in form/terms of symbol(s)/slot(s)/etc.) according to or based on: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. For example, candidate value(s) of t_offset could be {1, 2, . . . , 10, 20, 40, . . . } slot(s)/symbol(s)/ms/etc. For another example, t_offset could correspond to one or more of:
Periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
Periodicity of an event evaluation or event evaluation instance for determining an event instance according to or following those specified herein in the present disclosure
Periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). According to or following those specified herein in the present disclosure:
When/if the UE could determine or identify or declare an/the event within a k-th time window starting from time t−T−T_proc−k×t_offset and ending at time t−T_proc−k×t_offset according to or following those specified herein in the present disclosure, the UE could transmit or trigger or initiate a transmission of the PN message/trigger over/on/via/in the PUCCH resource or transmission or transmission occasion of the first UL channel at time t, and/or
When/if the UE could determine or identify or declare an/the event within a k-th time window starting from time t−T−T_proc−k×t_offset and ending at time t−T_proc−k×t_offset according to or following those specified herein in the present disclosure, the UE may not check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure, and/or
When/if the UE could not determine or identify or declare an/the event within a k-th time window starting from time t−T−T_proc−k×t_offset and ending at time t−T_proc−k×t_offset according to or following those specified herein in the present disclosure, the UE could further check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure.

In this case, kϵ{0, . . . , Kmax}, wherein the UE could determine or identify value(s) of k and/or Kmax according to or based on: 1) fixed value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.
In one example, the starting time t−T−T_proc−(Kmax+1)×t_offset of the Kmax-th time window could be no earlier than t−2×T−T_proc, and/or the ending time t−Tproc−(Kmax+1)×t_offset of the Kmax-th time window could be no earlier than t−T−T_proc.
In another example, the ending time t−T_proc−(Kmax+1)×t_offset of the Kmax-th time window could be no earlier than t−T_pucch−T_proc, wherein T_pucch (e.g., in form/terms of symbol(s)/slot(s)/etc.) represents the periodicity of/for the PUCCH resource(s).

The (second) time window(s) here can also be referred to as sliding time window(s) with a time offset t_offset.

In another example, when/if a UE has determined or identified or declared an event instance wherein:
for Event-1, the event instance could be associated/specific to at least one (same) new/candidate beam RS/RS resource according to or following those specified herein in the present disclosure,
for Event-2, the event instance could be associated/specific to the current beam RS/RS resource according to or following those specified herein in the present disclosure, and
for Event-3, the event instance could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
(higher layer(s) of) the UE could start a time window/timer;
according to or following those specified herein in the present disclosure, when/if (higher layer(s) of) the UE has determined or identified the aforementioned event instance before end of the time window and/or within the time window (e.g., before the last symbol/slot/etc. of the time window, wherein duration/length of the time window could be higher layer configured) and/or before the timer expires, (higher layer(s) of) the UE could increment an event instance count/counting for or of or specific to the new beam RS or RS resource by one;
before end of the time window and/or within the time window (e.g., before the last symbol/slot/etc. of the time window, wherein duration/length of the time window could be higher layer configured) and/or before the timer expires, when/if (higher layer(s) of) the UE has determined or identified that the number of the event instance(s) and/or the event instance count(s)/counting(s) is greater than or equal to maxCount (e.g., higher layer configured), (higher layer(s) of) the UE could determine or identify or declare a potential/candidate event occurrence.

For Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could first determine or identify a time duration starting from time t−T_du−T_proc (e.g., in form of a slot or a symbol, i.e., slot or symbol t−T_du−T_proc or the (t−T_du−T_proc)-th slot or symbol) and ending at time t−Tproc—e.g., the time duration here could be associated/specific/corresponding to the PUCCH resource or transmission or transmission occasion at time t. The UE (e.g., higher layer(s) of the UE) could determine or identify or declare an/the event when/if (higher layer(s) of) the UE could determine or identify or declare at least one potential/candidate event occurrence (or one or more potential/candidate event occurrences) according to or following those specified or described herein in the present disclosure within the aforementioned time duration associated/specific/corresponding to the PUCCH resource or transmission or transmission occasion at time t—for instance,
the start of the time window(s)/timer(s) used to determine or identify or declare the at least one (or the one or more) potential/candidate event occurrence(s) could be after or no earlier than the start of the time duration; and/or
the end of the time window(s) used to determine or identify or declare the at least one (or the one or more) potential/candidate event occurrence(s) could be before or no later than the end of the time duration, or the timer(s) used to determine or identify or declare the at least one (or the one or more) potential/candidate event occurrence(s) may not expire or may not be expired before or no later than the end of the time duration; and/or
the time window(s) used to determine or identify or declare the at least one (or the one or more) potential/candidate event occurrence(s) could be within the time duration
   and/or when/if one or more of the following conditions are achieved or satisfied:
The UE does not receive a TCI state update within the time duration,
The UE receives a TCI state update within the time duration, and the (measured) current beam RS/RS resource associated/specific to or determined/identified based on or according to the TCI state update or updated TCI state according to or following those specified herein in the present disclosure is not updated/changed in contrast to or different from the previous one,
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time duration,
The UE does not receive a (unified) TCI state(s) activation/deactivation MAC CE within the time duration,
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time duration,
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time duration, wherein the UE could determine or identify the value of m according to or following those specified herein in the present disclosure,
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time duration, wherein the UE could determine or identify the value of m according to or following those specified herein in the present disclosure,
The UE does not receive any form/format of a beam failure recover response (BFRR) within the time duration,
The UE or higher layer(s) of the UE does not start (or starts) a prohibit timer as defined/specified herein in the present disclosure within the time duration, and/or the prohibit timer expires (or does not expire) within the time duration,
For Mode-A/Mode-B, the UE does not receive a DCI in Step-2 in response to the transmission of the PN message/trigger in Step-1 within the time duration,
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time duration,
The UE does not receive triggering of aperiodic or semi-persistent CSI measurement and/or reporting (e.g., via a CSI request field in a triggering DCI) within the time duration, and
The UE does not receive activation of semi-persistent CSI measurement and/or reporting (e.g., via SP CSI measurement and/or reporting activation MAC CE(s)) within the time duration.

After the determination or identification or declaration of an/the event according to the time duration, the UE could transmit or trigger or initiate a transmission of the PN message/trigger over/on/via/in the PUCCH resource or transmission or transmission occasion of the first UL channel at time t. Here, the UE could determine or identify value(s) of the time duration and/or T_du according to or following: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
For example, T_du could correspond to or higher layer configured as T_pucch, wherein T_pucch represents the periodicity of the PUCCH resource(s)/transmission(s)/transmission occasion(s) of the first UL channel.
For another example, T_du could correspond to or higher layer configured as 0 or T_pucch or a value (e.g., in form/terms of number of symbol(s)/slot(s)/ms/etc.) in the range of [0, T_pucch], wherein T_pucch represents the periodicity of the PUCCH resource(s)/transmission(s)/transmission occasion(s) of the first UL channel.
For another example, T_du could correspond to or higher layer configured as the periodicity of an event evaluation or event evaluation instance for determining an event instance according to or following those specified herein in the present disclosure.
For another example, T_du could correspond to or higher layer configured as the periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure.
For another example, T_du could correspond to or higher layer configured as min{periodicity of a first MO, periodicity of a second MO}.
For another example, T_du could correspond to or higher layer configured as max{periodicity of a first MO, periodicity of a second MO}.
For another example, T_du could correspond to or higher layer configured as max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Furthermore, according to or following those specified herein in the present disclosure, i.e., for the operation(s) in Mode-A, Mode-B and/or Mode-C as specified/defined herein in the present disclosure, the UE could send or transmit to the network beam report(s)—e.g., via/in/by the (CG/DG) PUSCH resource(s) of the second UL channel—associated/specific to the transmission or triggering or initiation of the transmission of the PN message/trigger over/on/via/in the PUCCH resource or transmission or transmission occasion of the first UL channel at time t. In this case, the UE could determine or identify report content(s)/quantity(s) including at least SSBRI(s)/CRI(s) and/or L1-RSRP(s)/L1-SINR(s) of the beam report(s) based on or according to at least the new/candidate beam RS(s)/RS resource(s) associated or specific or corresponding to the potential/candidate event occurrence(s) determined or identified or declared by (higher layer(s) of) the UE within the time duration specific/corresponding/associated to the PUCCH resource or transmission or transmission occasion of the first UL channel at time t. For this example, the time window(s) associated/specific to the event instance(s) wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      could correspond to or could be sliding time window(s) as specified/defined herein in the present disclosure.

Throughout the present disclosure, when/if (higher layer(s) of) the UE starts a time window/timer of or for or specific to a new/candidate beam RS/RS resource for determining or identifying or declaring event instance(s) according to or following those specified herein in the present disclosure.
In one example, before the end of the time window or before the timer expires, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may start another time window/timer of or for or specific to a/the same new/candidate beam RS/RS resource for determining or identifying or declaring event instance(s) according to or following those specified herein in the present disclosure no earlier than the end of the time window or the expiration of the timer.
In another example, after (higher layer(s)) of the UE has started the time window/timer, (higher layer(s) of) the UE could start a prohibit timer specific/corresponding/associated to the time window/timer. In this case, when/if the prohibit timer is running, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may not start another time window/timer of or for or specific to a/the same new/candidate beam RS/RS resource for determining or identifying or declaring event instance(s) according to or following those specified herein in the present disclosure before the expiration of the prohibit timer. The UE could determine or identify value(s)/duration(s)/length(s) of the prohibit timer (e.g., in slot(s)/symbol(s)/ms/etc.) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Throughout the present disclosure, a time duration, a time window, a time offset, a time gap and/or etc. could be equivalent such that they can be used in an exchangeable manner.

Throughout the present disclosure, any time duration, time length, time window, time gap or time offset could be in form/terms of (number of) slot(s)/symbol(s) or milli-second, i.e., ms. Furthermore, throughout the present disclosure, within a time window/duration as specified/defined herein in the present disclosure, (higher layer(s) of) the UE could reset the counting of event instance(s), e.g., to zero, when/if one or more of the following conditions are achieved or satisfied:
The UE receives a TCI state update within the time window/duration,
The UE receives a TCI state update within the time window/duration, and the (measured) current beam RS/RS resource associated/specific to or determined/identified based on or according to the TCI state update or updated TCI state according to or following those specified herein in the present disclosure is updated/changed in contrast to or different from the previous one,
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window/duration,
The UE receives a (unified) TCI state(s) activation/deactivation MAC CE within the time window/duration,
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window/duration,
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window/duration, wherein the UE could determine or identify the value of m according to or following those specified herein in the present disclosure,
The UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window/duration, wherein the UE could determine or identify the value of m according to or following those specified herein in the present disclosure,
The UE receives a beam failure recover response (BFRR) within the time window/duration,
The UE or higher layer(s) of the UE starts (or does not start) a prohibit timer as defined/specified herein in the present disclosure within the time window/duration, and/or the prohibit timer does not expire (or expires) within the time window/duration,
For Mode-A/Mode-B, the UE receives a DCI in Step-2 in response to the transmission of the PN message/trigger in Step-1 within the time window/duration,
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window/duration
The UE receives triggering of aperiodic or semi-persistent CSI measurement and/or reporting (e.g., via a CSI request field in a triggering DCI) within the time window/duration,
The UE receives activation of semi-persistent CSI measurement and/or reporting (e.g., via SP CSI measurement and/or reporting activation MAC CE(s)) within the time window/duration,
   wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

For the (above) described or specified examples in the present disclosure, the UE could perform or conduct or carry out or do the aforementioned determination or identification or declaration of an/the event, and/or instance(s) of the aforementioned determination or identification or declaration of an/the event could be:
for each periodic PUCCH resource or transmission or transmission occasion of the first UL channel
based on or according to (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling
with a periodicity, wherein
   the periodicity could be the same as the periodicity of the PUCCH resource(s)/transmission(s)/transmission occasion(s) of the first UL channel
   the periodicity could be a fixed value in system specification(s) and/or per RRC (re-)configuration
   the periodicity could be determined by the UE and subject to a corresponding UE's capability/capability signaling
   the periodicity could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling
with a (minimum) time gap/offset between two adjacent or neighboring instances of determination or identification or declaration of an/the event, wherein
   the (minimum) time gap/offset could be the same as the periodicity of the PUCCH resource(s)/transmission(s)/transmission occasion(s) of the first UL channel
   the (minimum) time gap/offset could be a fixed value in system specification(s) and/or per RRC (re-)configuration
   the (minimum) time gap/offset could be determined by the UE and subject to a corresponding UE's capability/capability signaling
   the (minimum) time gap/offset could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling

For the (above) described or specified examples in the present disclosure, within the time window, when/if the UE
receives a TCI state update
receives a TCI state update, and the (measured) current beam RS/RS resource associated/specific to or determined/identified based on or according to the TCI state update or updated TCI state according to or following those specified herein in the present disclosure is updated/changed in contrast to or different from the previous one
receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
receives a (unified) TCI state(s) activation/deactivation MAC CE
receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure
receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
receives a beam failure recover response (BFRR)
starts (or does not start) a prohibit timer as defined/specified herein in the present disclosure, and/or the prohibit timer does not expire (or expires)
for Mode-A/Mode-B, receives a DCI in Step-2 in response to the transmission of the PN message/trigger in Step-1
receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
receives triggering of aperiodic or semi-persistent CSI measurement and/or reporting (e.g., via a CSI request field in a triggering DCI)
receives activation of semi-persistent CSI measurement and/or reporting (e.g., via SP CSI measurement and/or reporting activation MAC CE(s)),
   the UE could reset the number/counting of the event instance(s) determined or identified or declared
within the corresponding time window
before the reception of the TCI state update
before the reception of the (unified) TCI state(s) activation/deactivation MAC CE
for Mode-A/Mode-B, before the reception of the DCI in Step-2 in response to the transmission of the PN message/trigger in Step-1
before the reception of the reconfiguration of new beam RS(s) or RS resource(s)
before the reception of the triggering of aperiodic or semi-persistent CSI measurement and/or reporting (e.g., via a CSI request field in a triggering DCI)
before the reception of the activation of semi-persistent CSI measurement and/or reporting (e.g., via SP CSI measurement and/or reporting activation MAC CE(s))
   to zero, wherein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In one example, for one or more RSs or RS resources each corresponding to one or more of: (1) a (same) new/candidate beam RS/RS resource (e.g., for Event-1 or Event-3), (2) the current beam RS/RS resource (e.g., for Event-2), (3) (a pair of) a (same) new/candidate beam RS/RS resource and a (same) activation beam RS/RS resource (or equivalently, a (same) activated beam/TCI state)—e.g., for Event-3, the MAC entity of/for a UE could or shall for each Serving Cell configured/enabled for UE-initiated/event-driven beam reporting according to those specified herein in the present disclosure:
1> to initiate or trigger a UEI/event-driven beam reporting based on or according to detection or declaration or determination of an event (e.g., Event-1, Event-2 and/or Event-3 in the present disclosure), e.g., to transmit or trigger or initiate a transmission of the PN message/trigger over/on/via/in the PUCCH resource or PUCCH transmission or PUCCH transmission occasion of the first UL channel in Mode A and/or Mode B and/or Mode C at time t:
   2> if an indication for an event instance (e.g., an Event-1 instance or an Event-2 instance or an Event-3 instance) associated/specific to the one or more RSs or RS resources determined or identified according to or following those specified herein in the present disclosure has been received from lower layers:
      3> start or restart an EventInstanceDetectionTimer (higher layer configured for the event—when/if applicable), e.g., associated/specific to the one or more RSs or RS resources;
      3> increment an EventInstanceCounter (higher layer configured for the event—when/if applicable), e.g., associated/specific to the one or more RSs or RS resources by 1;
      3> if EventInstanceCounter>=EventInstanceMaxCount (higher layer configured for the event—when/if applicable), identify or determine or detect or declare a first potential/candidate event occurrence, e.g., associated/specific to the one or more RSs or RS resources, according to or following those specified herein in the present disclosure:
         4> if the identification or determination or detection or declaration of the first potential/candidate event occurrence is within a time duration starting from time t−T_du−T_proc (e.g., in form of a slot or a symbol, i.e., slot or symbol t−T_du−T_proc or the (t−T_du−T_proc)-th slot or symbol) and ending at time t−T_proc—e.g., the time duration here could be associated/specific/corresponding to the PUCCH resource or transmission or transmission occasion of the first UL channel in Mode-A and/or Mode-B and/or Mode-C at time t, wherein T_du, T_proc and/or etc. could be determine or identified according to or following those specified herein in the present disclosure, and/or
         4> if there is no other potential/candidate event occurrence(s), e.g., associated/specific to the same one or more RSs or RS resources, identified or determined within the aforementioned time window starting from time t−T_du−T_proc (e.g., in form of a slot or a symbol, i.e., slot or symbol t−T_du−T_proc or the (t−T_du−T_proc)-th slot or symbol) and ending at time t−T_proc and later in time than the identification or determination or detection of the first potential/candidate event occurrence
         5> trigger or initiate a transmission of the PN message/trigger over/on/via/in the PUCCH resource or PUCCH transmission or PUCCH transmission occasion of the first UL channel at time t according to or based on (identification, determination, detection or declaration of) at least the first potential/candidate event occurrence, wherein the report content(s)/quantity(s) in the UEI beam report(s) could be determined or identified according to or based on (identification, determination, detection or declaration of) at least the first potential/candidate event occurrence (hence, the one or more RSs or RS resources associated/specific to the first potential/candidate event occurrence);
   2> if one or more of the following conditions are satisfied or achieved:
      the EventInstanceDetectionTimer, e.g., associated/specific to the one or more RSs or RS resources, expires
      the UE receives a TCI state update
      the UE receives a (unified) TCI state(s) activation/deactivation MAC CE
      the UE receives a (unified) TCI state(s) activation/deactivation MAC CE that activates or updates the activation beam RS(s)/RS resource(s), and therefore, the corresponding activated beam(s)/TCI state(s), used for determining or identifying the first candidate/potential event occurrence according to or following those specified herein in the present disclosure
      the UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command used for determining or identifying the first candidate/potential event occurrence according to or following those specified herein in the present disclosure, wherein the UE could determine or identify the value of m according to or following those specified herein in the present disclosure
      the UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure—used for determining or identifying the first candidate/potential event occurrence, wherein the UE could determine or identify the value of m according to or following those specified herein in the present disclosure
      the UE receives a beam failure recover response (BFRR)
      for Mode-A/Mode-B, the UE receives a DCI in Step-2 in response to the transmission of the PN message/trigger in Step-1
      the UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
      the UE receives reconfiguration/update/addition/removal/release (e.g., via/by/in upper layer(s) and/or RRC signaling(s) and/or MAC CE command(s) and/or dynamic DCI based L1 signaling(s)) of the one or more RSs or RS resources
      the UE receives triggering of aperiodic or semi-persistent CSI measurement and/or reporting (e.g., via a CSI request field in a triggering DCI)
      the UE receives activation of semi-persistent CSI measurement and/or reporting (e.g., via SP CSI measurement and/or reporting activation MAC CE(s))
      3> set EventInstanceCounter, e.g., associated/specific to the one or more RSs or RS resources, to 0.

The one or more RSs or RS resources could belong to or could be a subset of or one(s) of all the RS(s) or RS resource(s) configured, provided, determined or identified for event evaluation(s) according to or following those specified/described herein in the present disclosure, wherein one or more of or each of the RS(s) or RS resource(s) configured, provided, determined or identified for event evaluation(s) could correspond to one or more of:
the current beam RS/RS resource
new/candidate beam RS(s)/RS resource(s) in the corresponding resource set
activation beam RS(s)/RS resource(s) in the corresponding activated TCI state(s), e.g., provided/indicated in a (unified) TCI state(s) activation/deactivation MAC CE
Pair(s) of new/candidate beam RS(s)/RS resource(s) in the corresponding resource set and activation beam RS(s)/RS resource(s) in the corresponding activated TCI state(s), e.g., provided/indicated in a (unified) TCI state(s) activation/deactivation MAC CE

According to or following those specified herein in the present disclosure, a UE or higher layer(s) of the UE could trigger or initiate a transmission of the PN message/trigger over/on/via/in the PUCCH resource or PUCCH transmission or PUCCH transmission occasion of the first UL channel in Mode A and/or Mode B and/or Mode C according to or based on (identification, determination, detection or declaration of) one or more potential/candidate event occurrences, wherein each of the one or more potential/candidate event occurrences could be associated/specific to different/separate (sets of) RSs or RS resources. In this case, the corresponding UEI/event-driven beam report(s)—e.g., carried or conveyed or transmitted or sent via PUSCH resource(s) of the second UL channel in Mode A and/or Mode B and/or Mode C associated/specific to the transmission of the PN message/trigger over/on/via/in the PUCCH resource or PUCCH transmission or PUCCH transmission occasion of the first UL channel in Mode A and/or Mode B and/or Mode C—could comprise or include or contain report content(s)/quantity(s) including resource indicator(s) such as SSBRI(s)/CRI(s) and beam metric(s) such as L1-RSRP(s)/L1-SINR(s) determined or identified according to or based on (identification, determination, detection or declaration of) the one or more potential/candidate event occurrences (hence, the RS(s) or RS resource(s) associated/specific to the potential/candidate event occurrence(s)).

A UE or higher layer(s) of a UE could start a prohibit timer (duration, length and/or etc. of the prohibit timer and/or how/when the prohibit timer would expire could be higher layer configured)
after the last symbol/slot/etc. of transmitting a PN message/trigger on/over/in a PUCCH resource or a PUCCH transmission/transmission occasion of the first UL channel of Mode A and/or Mode B and/or Mode C, and/or
after the last symbol/slot/etc. of receiving the UL grant DCI in Step-2 of Mode A and/or Mode C, and/or
after the last symbol/slot/etc. of when the UL grant DCI received in Step-2 of Mode A and/or Mode C has become applicable, and/or
after the last symbol/slot/etc. of transmitting a beam report on/over/in (DG and/or CG e.g., Type1 CG) PUSCH resource(s) of the second UL channel of Mode A and/or Mode B and/or Mode C.

When a prohibit timer is running, the UE or higher layer(s) of the UE may not transmit any PN message(s)/trigger(s)/notification(s) on/over/in a PUCCH resource or a PUCCH transmission/transmission occasion of the first UL channel (e.g., in Mode A, Mode B and/or Mode C). That is, only when there is no prohibit timer running, the UE or higher layer(s) of the UE could transmit a PN message/trigger on/over/in a PUCCH resource or a PUCCH transmission/transmission occasion of the first UL channel (e.g., in Mode A, Mode B and/or Mode C). In addition, when/if a prohibit timer is running, and/or when/if the duration, length and/or etc. of the prohibit timer is less/smaller (or larger/greater) than or equal to a threshold,
in one example, the UE or higher layer(s) of the UE could continue performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE may not reset the number/counting of the event instance(s), e.g., to zero, and could continue/keep incrementing the number/counting of the (same) event instance(s) counted before the prohibit timer starts according to or following those specified herein in the present disclosure;
   for another example, when/if the UE or higher layer(s) of the UE starts the prohibit timer, the UE or higher layer(s) of the UE could or may reset the number/counting of the event instance(s), e.g., to zero;
   for another example, when/if or after the prohibit timer expires, the UE or higher layer(s) of the UE could or may reset the number/counting of the event instance(s), e.g., to zero;
in another example, the UE or higher layer(s) of the UE could stop performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE could or may reset the number/counting of the event instance(s), e.g., to zero;
   for another example, when/if the UE or higher layer(s) of the UE starts the prohibit timer, the UE or higher layer(s) of the UE may not reset the number/counting of the event instance(s), e.g., to zero, and when/if or after the prohibit timer expires, the UE or higher layer(s) of the UE could continue/keep incrementing the number/counting of the (same) event instance(s) counted before the prohibit timer starts according to or following those specified herein in the present disclosure

The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n times with n=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Otherwise, e.g., when/if a prohibit timer is running, and/or when/if the duration, length and/or etc. of the prohibit timer is larger/greater (or less/smaller) than or equal to the threshold specified herein in the present disclosure,
the UE or higher layer(s) of the UE could stop performing or conducting the event evaluation(s) including counting of the event instance(s) according to or following those specified herein in the present disclosure, and/or
when/if the UE or higher layer(s) of the UE starts the prohibit timer, the UE or higher layer(s) of the UE could or may reset the number/counting of the event instance(s), e.g., to zero, and/or
when/if or after the prohibit timer expires, the UE or higher layer(s) of the UE could or may reset the number/counting of the event instance(s), e.g., to zero, and/or
when/if or after the prohibit timer expires, the UE or higher layer(s) of the UE may not continue/keep incrementing the number/counting of the (same) event instance(s) counted before the prohibit timer starts according to or following those specified herein in the present disclosure.

Regarding the event instance(s) specified/discussed herein:
for Event-1, the event instance(s) could be associated/specific to at least one (same) new/candidate beam RS/RS resource according to or following those specified herein in the present disclosure,
for Event-2, the event instance(s) could be associated/specific to the current beam RS/RS resource according to or following those specified herein in the present disclosure, and
for Event-3, the event instance(s) could be:
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In addition, UE could determine or identify the value of n according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, when/if a UE or higher layer(s) of a UE has determined or detected or declared an event and there is no prohibit timer running, the UE could transmit a PN message/trigger on/over/in/by a first PUCCH resource or a first PUCCH transmission/transmission occasion (of the first UL channel) at time t, wherein the UE could determine or identify association(s)/linkage(s)/correspondence(s)—e.g., in terms of their timing relations—between the determination or detection or declaration of the event and the first PUCCH resource or first PUCCH transmission or first PUCCH transmission occasion at time t according to or following those specified herein in the present disclosure. When/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′ to transmit a PN message/trigger based on the determination, detection or declaration of the event according to or following those specified herein in the present disclosure, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′.

Furthermore, delta_t=t′−t could be smaller/less (or larger/greater) than or equal to a threshold. The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n′ times with n′=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). In addition, the UE could determine or identify the value of n′ according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Alternatively, when/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′. When/if delta_t=t′−t is greater/larger (or less/smaller) than or equal to the threshold specified herein in the present disclosure, the UE may not transmit a PN message/trigger on/over/in/by the second PUCCH resource or second PUCCH transmission/transmission occasion of the first UL channel at time t′ based on the determination, detection or declaration of the event according to or following those specified herein in the present disclosure, and/or
the UE may not transmit any PN message(s)/trigger(s) on/over/in/by any PUCCH resource(s) or any PUCCH transmission(s)/transmission occasion(s) of the first UL channel based on the determination, detection or declaration of the event according to or following those specified herein in the present disclosure.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/L1/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/L1/lower layer(s)

That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

In one embodiment, a UE is configured to transmit K PUCCHs for respective K−L SRs or L UEIRIs in a slot, where K≥L and L≥0, as determined by a set of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, a schedulingRequestResourceId associated with schedulingRequestID-LBT-SCell, and a set of firstPUCCHResourceConfig-UEIRId with SR or UEIRIs transmission occasions that would overlap with a transmission of a PUCCH with HARQ-ACK information from the UE in the slot or with a transmission of a PUCCH with CSI report(s) from the UE in the slot.

If a UE would transmit a PUCCH with positive SR or UEIRI and at most two HARQ-ACK information bits in a resource using PUCCH format 0, the UE transmits the PUCCH in the resource using PUCCH format 0 in PRB(s) for HARQ-ACK information as described in clause 9.2.3 of REF 3. The UE determines a value of m₀ and m_{CS} for computing a value of cyclic shift a [4, REF 1] where m₀ is provided by initialCyclicShift of PUCCH-format0, and m_{CS} is determined from the value of one HARQ-ACK information bit or from the values of two HARQ-ACK information bits as in Table 6 and Table 7 below, respectively.

If the UE would transmit negative SR or UEIRI and a PUCCH with at most two HARQ-ACK information bits in a resource using PUCCH format 0, the UE transmits the PUCCH in the resource using PUCCH format 0 for HARQ-ACK information as described in clause 9.2.3 of REF 3.

TABLE 6
Mapping of values for one HARQ-ACK information
bit and positive SR or UEIRI to sequences for
PUCCH format 0

| HARQ-ACK Value | 0 | 1 |
|---|---|---|
| Sequence cyclic shift | m_{cs} = 3 | m_{cs} = 9 |

TABLE 7
Mapping of values for two HARQ-ACK information
bits and positive SR or UEIRI to sequences for
PUCCH format 0

| HARQ-ACK Value | {0, 0} | {0, 1} | {1, 1} | {1, 0} |
|---|---|---|---|---|
| Sequence cyclic shift | m_{cs} = 1 | m_{cs} = 4 | m_{cs} = 7 | m_{cs} = 10 |

If a UE would transmit SR or UEIRI in a resource using PUCCH format 0 and HARQ-ACK information bits in a resource using PUCCH format 1 in a slot, the UE transmits only a PUCCH with the HARQ-ACK information bits in the resource using PUCCH format 1.

If the UE would transmit positive SR or UEIRI in a first resource using PUCCH format 1 and at most two HARQ-ACK information bits in a second resource using PUCCH format 1 in a slot, the UE transmits a PUCCH with HARQ-ACK information bits in the first resource using PUCCH format 1 as described in clause 9.2.3 of REF 3. If a UE would not transmit a positive SR nor UEIRI in a resource using PUCCH format 1 and would transmit at most two HARQ-ACK information bits in a resource using PUCCH format 1 in a slot, the UE transmits a PUCCH in the resource using PUCCH format 1 for HARQ-ACK information as described in clause 9.2.3 of REF 3.

If a UE would transmit a PUCCH with O_{ACK} HARQ-ACK information bits in a resource using PUCCH format 2 or PUCCH format 3 or PUCCH format 4 in a slot, as described in clauses 9.2.1 and 9.2.3 of REF 3, ┌log₂(K+1)┐ bits representing a negative or positive SR or UEIRI, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, and then in ascending order of the values of firstPUCCHResourceConfig-UEIRId, are appended to the HARQ-ACK information bits and the UE transmits the combined O_{UCI}=O_{ACK}+┌log₂(K+1)┐ UCI bits in a PUCCH using a resource with PUCCH format 2 or PUCCH format 3 or PUCCH format 4 that the UE determines as described in clauses 9.2.1 and 9.2.3 of REF 3. If one of the SRs is a positive LRR, the value of the ┌log₂(K+1)┐ bits indicates the positive LRR, else, if one of the UEIRIs is a positive UEIRI, the value of the ┌log₂(K+1)┐ bits indicates the positive UEIRI. An all-zero value for the ┌log₂(K+1)┐ bits represents a negative SR or UEIRI value across all K SRs or UEIRIs.

If a UE would transmit a PUCCH with O_{CSI} CSI report bits in a resource using PUCCH format 2 or PUCCH format 3 or PUCCH format 4 in a slot, ┌log₂(K+1)┐ bits representing corresponding negative or positive SR or UEIRI, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, and then in ascending order of the values of firstPUCCHResourceConfig-UEIRId, are prepended to the CSI information bits as described in clause 9.2.5.2 of REF 3 and the UE transmits a PUCCH with the combined O_{UCI}=┌log₂(K+1)┐+O_{CSI} UCI bits in a resource using the PUCCH format 2 or PUCCH format 3 or PUCCH format 4 for CSI reporting. If one of the SRs is a positive LRR, the value of the ┌log₂(K+1)┐ bits indicates the positive LRR, else, if one of the UEIRIs is a positive UEIRI, the value of the ┌log₂(K+1)┐ bits indicates the positive UEIRI. An all-zero value for the ┌log₂(K+1)┐ bits represents a negative SR or UEIRI value across all K SRs or UEIRIs.

If a UE transmits a PUCCH with O_{ACK} HARQ-ACK information bits, O_{SR}=┌log₂(K+1)┐ SR or UEIRI bits, and O_{CRC} CRC bits using PUCCH format 2 or PUCCH format 3 in a PUCCH resource that includes

$${M}_{RB}^{PUCCH} PRBs ,$$

the UE determines a number of PRBs

$${M}_{RB , m i n}^{PUCCH}$$

for the PUCCH transmission to be the minimum number of PRBs, that is smaller than or equal to a number of PRBs provided by nrofPRBs in PUCCH-format2 or nrofPRBs in PUCCH-format3 and starts from the first PRB from the number of PRBs, that results to

$$( {O}_{ACK} + {O}_{SR} + {O}_{CRC} ) \leq {M}_{RB , m i n}^{PUCCH} \cdot {N}_{sc , ctrl}^{RB} \cdot {N}_{symb - UCI}^{PUCCH} \cdot {Q}_{m} \cdot r and , if {M}_{RB}^{PUCCH} > 1 , ( {O}_{ACK} + {O}_{SR} + {O}_{CRC} ) > ( {M}_{RB , m i n}^{PUCCH} - 1 ) \cdot {N}_{sc , ctrl}^{RB} \cdot {N}_{symb - UCI}^{PUCCH} \cdot {Q}_{m} \cdot r ,$$

where

$${N}_{sc , ctrl}^{RB} , {N}_{symb - UCI}^{PUCCH} , {Q}_{m} ,$$

and r are defined in clause 9.2.5.2 of REF 3. For PUCCH format 3, if

$${M}_{RB , m i n}^{PUCCH}$$

is not equal 2^{α}^{₂}·3^{α}^{₃}·5^{α}^{₅} according to [4, REF 1],

$${M}_{RB , m i n}^{PUCCH}$$

is increased to the nearest allowed value of nrofPRBs [12, REF 6]. If

$$( {O}_{ACK} + {O}_{SR} + {O}_{CRC} ) > ( {M}_{RB}^{PUCCH} - 1 ) \cdot {N}_{sc , ctrl}^{RB} \cdot {N}_{symb - UCI}^{PUCCH} \cdot {Q}_{m} \cdot r ,$$

the UE transmits the PUCCH over the

$${M}_{RB}^{PUCCH} PRBs .$$

If a UE is provided a first interlace of

$${M}_{Interlace , 0}^{PUCCH} PRBs$$

by interlace0 in InterlaceAllocation and transmits a PUCCH with O_{ACK} HARQ-ACK information bits, O_{SR}=┌log₂(K+1)┐SR or UEIRI bits, and O_{CRC} CRC bits using PUCCH format 2 or PUCCH format 3, the UE transmits the PUCCH over the first interlace if

$$( {O}_{ACK} + {O}_{SR} + {O}_{CRC} ) \leq {M}_{Interlace , 0}^{PUCCH} \cdot {N}_{sc , ctrl}^{RB} \cdot {N}_{symb - UCI}^{PUCCH} \cdot {Q}_{m} \cdot r ;$$

otherwise, if the UE is provided a second interlace by interlace1 in PUCCH-format2 or PUCCH-format3, the UE transmits the PUCCH over the first and second interlaces.

In one embodiment, a UE is configured to transmit K PUCCHs for respective
K−L SRs in a slot, as determined by a set of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, and
L PUCCHs for respective L UEIRIs in a slot as determined by a set of firstPUCCHResourceConfig-UEIRId
   with SR transmission occasions or UEIRI transmission occasions that would overlap with a transmission of a PUCCH with HARQ-ACK information from the UE in the slot or with a transmission of a PUCCH with CSI report(s) from the UE in the slot.

If a UE would transmit a PUCCH with positive SR/UEIRI and at most two HARQ-ACK information bits in a resource using PUCCH format 0, the UE transmits the PUCCH in the resource using PUCCH format 0 in PRB(s) for HARQ-ACK information as described in clause 9.2.3 of REF 3. The UE determines a value of m₀ and m_{CS} for computing a value of cyclic shift a [4, REF1] where m₀ is provided by initialCyclicShift of PUCCH-format0, and m_{CS} is determined from the value of one HARQ-ACK information bit or from the values of two HARQ-ACK information bits as in Table 8 and Table 9 below, respectively.

If the UE would transmit negative SR/UEIRI and a PUCCH with at most two HARQ-ACK information bits in a resource using PUCCH format 0, the UE transmits the PUCCH in the resource using PUCCH format 0 for HARQ-ACK information as described in clause 9.2.3 of REF 3.

TABLE 8
Mapping of values for one HARQ-ACK information
bit and positive SR/UEIRI to sequences for
PUCCH format 0

| HARQ-ACK Value | 0 | 1 |
|---|---|---|
| Sequence cyclic shift | m_{cs} = 3 | m_{cs} = 9 |

TABLE 9
Mapping of values for two HARQ-ACK information
bits and positive SR/UEIRI to sequences for
PUCCH format 0

| HARQ-ACK Value | {0, 0} | {0, 1} | {1, 1} | {1, 0} |
|---|---|---|---|---|
| Sequence cyclic shift | m_{cs} = 1 | m_{cs} = 4 | m_{cs} = 7 | m_{cs} = 10 |

If a UE would transmit SR/UEIRI in a resource using PUCCH format 0 and HARQ-ACK information bits in a resource using PUCCH format 1 in a slot, the UE transmits only a PUCCH with the HARQ-ACK information bits in the resource using PUCCH format 1.

If the UE would transmit positive SR/UEIRI in a first resource using PUCCH format 1 and at most two HARQ-ACK information bits in a second resource using PUCCH format 1 in a slot, the UE transmits a PUCCH with HARQ-ACK information bits in the first resource using PUCCH format 1 as described in clause 9.2.3 of REF 3. If a UE would not transmit a positive SR/UEIRI in a resource using PUCCH format 1 and would transmit at most two HARQ-ACK information bits in a resource using PUCCH format 1 in a slot, the UE transmits a PUCCH in the resource using PUCCH format 1 for HARQ-ACK information as described in clause 9.2.3 of REF 3.

If a UE would transmit a PUCCH with O_{ACK} HARQ-ACK information bits in a resource using PUCCH format 2 or PUCCH format 3 or PUCCH format 4 in a slot, as described in clauses 9.2.1 and 9.2.3 of REF 3, ┌log₂(K+1)┐ bits representing a negative or positive SR/UEIRI, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell for SR, and then in ascending order of the values of firstPUCCHResourceConfig-UEIRId for UEIRI, are appended to the HARQ-ACK information bits and the UE transmits the combined O_{UCI}=O_{ACK}+┌log₂(K+1)┐UCI bits in a PUCCH using a resource with PUCCH format 2 or PUCCH format 3 or PUCCH format 4 that the UE determines as described in clauses 9.2.1 and 9.2.3 of REF 3. If one of the SRs is a positive LRR, the value of the ┌log₂(K+1)┐ bits indicates the positive LRR; else, if one of the UEIRIs is a positive UEIRI, the value of the ┌log₂(K+1)┐ bits indicates the positive UEIRI. An all-zero value for the ┌log₂(K+1)┐ bits represents a negative SR/UEIRI value across all K SRs and UEIRIs.

If a UE would transmit a PUCCH with O_{CSI} CSI report bits in a resource using PUCCH format 2 or PUCCH format 3 or PUCCH format 4 in a slot, ┌log₂(K+1)┐ bits representing corresponding negative or positive SR/UEIRI, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell for SR, and then in ascending order of the values of firstPUCCHResourceConfig-UEIRId for UEIRI, are prepended to the CSI information bits as described in clause 9.2.5.2 of REF 3 and the UE transmits a PUCCH with the combined O_{UCI}=┌log₂(K+1)┐+O_{CSI} UCI bits in a resource using the PUCCH format 2 or PUCCH format 3 or PUCCH format 4 for CSI reporting. If one of the SRs is a positive LRR, the value of the ┌log₂(K+1)┐ bits indicates the positive LRR. An all-zero value for the ┌log₂(K+1)┐ bits represents a negative SR/UEIRI value across all K SRs and UEIRIs.

If a UE transmits a PUCCH with O_{ACK} HARQ-ACK information bits, O_{SR}=┌log₂(K+1)┐ SR/UEIRI bits, and O_{CRC} CRC bits using PUCCH format 2 or PUCCH format 3 in a PUCCH resource that includes

$${M}_{RB}^{PUCCH} PRBs ,$$

the UE determines a number of PRBs

$${M}_{RB , m i n}^{PUCCH}$$

for the PUCCH transmission to be the minimum number of PRBs, that is smaller than or equal to a number of PRBs provided by nrofPRBs in PUCCH-format2 or nrofPRBs in PUCCH-format3 and starts from the first PRB from the number of PRBs that results to

$$( {O}_{ACK} + {O}_{SR} + {O}_{CRC} ) \leq {M}_{RB , m i n}^{PUCCH} \cdot {N}_{sc , ctrl}^{RB} \cdot {N}_{symb - UCI}^{PUCCH} \cdot {Q}_{m} \cdot r and , if {M}_{RB}^{PUCCH} > 1 , ( {O}_{ACK} + {O}_{SR} + {O}_{CRC} ) > ( {M}_{RB , m i n}^{PUCCH} - 1 ) \cdot {N}_{sc , ctrl}^{RB} \cdot {N}_{symb - UCI}^{PUCCH} \cdot {Q}_{m} \cdot r , where {N}_{sc , ctrl}^{RB} , {N}_{symb - UCI}^{PUCCH} , {Q}_{m} ,$$

and r are defined in clause 9.2.5.2 of REF 3. For PUCCH format 3, if

$${M}_{RB , m i n}^{PUCCH}$$

is not equal 2^{α}^{₂}·3^{α}^{₃}·5^{α}^{₅} according to [4, REF 1],

$${M}_{RB , m i n}^{PUCCH}$$

is increased to the nearest allowed value of nrofPRBs [12, REF 6]. If

$$( {O}_{ACK} + {O}_{SR} + {O}_{CRC} ) > ( {M}_{RB}^{PUCCH} - 1 ) \cdot {N}_{sc , ctrl}^{RB} \cdot {N}_{symb - UCI}^{PUCCH} \cdot {Q}_{m} \cdot r ,$$

the UE transmits the PUCCH over the

$${M}_{RB}^{PUCCH}$$

### RBs.

If a UE is provided a first interlace of

$${M}_{Interlace , 0}^{PUCCH} PRBs$$

by interlace0 in InterlaceAllocation and transmits a PUCCH with O_{ACK} HARQ-ACK information bits, O_{SR}=┌log₂(K+1)┐SR/UEIRI bits, and O_{CRC} CRC bits using PUCCH format 2 or PUCCH format 3, the UE transmits the PUCCH over the first interlace if

$$( {O}_{ACK} + {O}_{SR} + {O}_{CRC} ) \leq {M}_{Interlace , 0}^{PUCCH} \cdot {N}_{sc , ctrl}^{RB} \cdot {N}_{symb - UCI}^{PUCCH} \cdot {Q}_{m} \cdot r ;$$

otherwise, if the UE is provided a second interlace by interlace1 in PUCCH-format2 or PUCCH-format3, the UE transmits the PUCCH over the first and second interlaces.

In one embodiment, a UE is configured to transmit
K PUCCHs for respective K SRs in a slot, as determined by a set of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, or
L PUCCHs for respective L UEIRIs in a slot as determined by a set of firstPUCCHResourceConfg-UEIRId
   with SR transmission occasions or UEIRI transmission occasions that would overlap with a transmission of a PUCCH with HARQ-ACK information from the UE in the slot or with a transmission of a PUCCH with CSI report(s) from the UE in the slot.

In the following, if a UE
would transmit SR and would not transmit UEIRI in a slot, ┌log₂(K+1)┐ bits represent a negative or positive UEIRI in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell
   if one of the SRs is a positive LRR, the value of the ┌log₂(K+1)┐ bit indicates the positive LRR
   an all-zero value for the ┌log₂(K+1)┐ bits represents a negative SR across all K SRs
would not transmit SR and would transmit UEIRI in a slot, UEIRI is considered as SR and K is replaced by L and ┌log₂(L+1)┐ bits represent a negative or positive UEIRI in ascending order of the values of firstPUCCHResourceConfig-UEIRId
   an all-zero value for the ┌log₂(L+1)┐ bit represents a negative UEIRI across all L UEIRIs
would transmit SR and would transmit UEIRI in a slot, UEIRI is considered as SR and K is replaced by K+L, first bits of ┌log₂(K+L+1)┐ bits represent a negative or positive SR, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, and remaining bits of the ┌log₂(K+L+1)┐ bits represent a negative or positive UEIRI in ascending order of the values of firstPUCCHResourceConfig-UEIRId
   an all-zero value for the ┌log₂(K+L+1)┐ bit represents a negative SR across all K SRs and a negative UEIRI across all L UEIRIs

If a UE would transmit a PUCCH with positive SR and at most two HARQ-ACK information bits in a resource using PUCCH format 0, the UE transmits the PUCCH in the resource using PUCCH format 0 in PRB(s) for HARQ-ACK information as described in clause 9.2.3 of REF 3. The UE determines a value of m₀ and m_{CS} for computing a value of cyclic shift a [4, REF 1] where m₀ is provided by initialCyclicShift of PUCCH-format0, and m_{CS} is determined from the value of one HARQ-ACK information bit or from the values of two HARQ-ACK information bits as in Table 10 and Table 11 below, respectively.

If the UE would transmit negative SR and a PUCCH with at most two HARQ-ACK information bits in a resource using PUCCH format 0, the UE transmits the PUCCH in the resource using PUCCH format 0 for HARQ-ACK information as described in clause 9.2.3 of REF 3.

TABLE 10
Mapping of values for one HARQ-ACK information
bit and positive SR to sequences for PUCCH
format 0

| HARQ-ACK Value | 0 | 1 |
|---|---|---|
| Sequence cyclic shift | m_{cs} = 3 | m_{cs} = 9 |

TABLE 11
Mapping of values for two HARQ-ACK information
bits and positive SR to sequences for PUCCH
format 0

| HARQ-ACK Value | {0, 0} | {0, 1} | {1, 1} | {1, 0} |
|---|---|---|---|---|
| Sequence cyclic shift | m_{cs} = 1 | m_{cs} = 4 | m_{cs} = 7 | m_{cs} = 10 |

If a UE would transmit SR in a resource using PUCCH format 0 and HARQ-ACK information bits in a resource using PUCCH format 1 in a slot, the UE transmits only a PUCCH with the HARQ-ACK information bits in the resource using PUCCH format 1.

If the UE would transmit positive SR in a first resource using PUCCH format 1 and at most two HARQ-ACK information bits in a second resource using PUCCH format 1 in a slot, the UE transmits a PUCCH with HARQ-ACK information bits in the first resource using PUCCH format 1 as described in clause 9.2.3 of REF 3. If a UE would not transmit a positive SR in a resource using PUCCH format 1 and would transmit at most two HARQ-ACK information bits in a resource using PUCCH format 1 in a slot, the UE transmits a PUCCH in the resource using PUCCH format 1 for HARQ-ACK information as described in clause 9.2.3 of REF 3.

If a UE would transmit a PUCCH with O_{ACK} HARQ-ACK information bits in a resource using PUCCH format 2 or PUCCH format 3 or PUCCH format 4 in a slot, as described in clauses 9.2.1 and 9.2.3 of REF 3, ┌log₂(K+1)┐ bits are appended to the HARQ-ACK information bits and the UE transmits the combined O_{UCI}=O_{ACK}+┌log₂(K+1)┐ UCI bits in a PUCCH using a resource with PUCCH format 2 or PUCCH format 3 or PUCCH format 4 that the UE determines as described in clauses 9.2.1 and 9.2.3 of REF 3.

If a UE would transmit a PUCCH with O_{CSI} CSI report bits in a resource using PUCCH format 2 or PUCCH format 3 or PUCCH format 4 in a slot, O_{SR}=┌log₂(K+1)┐ SR bits are prepended to the CSI information bits as described in clause 9.2.5.2 of REF 3 and the UE transmits a PUCCH with the combined O_{UCI}=┌log₂(K+1)┐+O_{CSI} UCI bits in a resource using the PUCCH format 2 or PUCCH format 3 or PUCCH format 4 for CSI reporting.

If a UE transmits a PUCCH with O_{ACK} HARQ-ACK information bits, O_{SR}=┌log₂(K+1)┐ SR bits, and O_{CRC} CRC bits using PUCCH format 2 or PUCCH format 3 in a PUCCH resource that includes

$${M}_{RB}^{PUCCH} PRBs ,$$

the UE determines a number of PRBs

$$PRBs {M}_{RB , m i n}^{PUCCH}$$

for the PUCCH transmission to be the minimum number of PRBs, that is smaller than or equal to a number of PRBs provided by nrofPRBs in PUCCH-format2 or nrofPRBs in PUCCH-format3 and starts from the first PRB from the number of PRBs, that results to

$$( {O}_{ACK} + {O}_{SR} + {O}_{CRC} ) \leq {M}_{RB , m i n}^{PUCCH} \cdot {N}_{sc , ctrl}^{RB} \cdot {N}_{symb - UCI}^{PUCCH} \cdot {Q}_{m} \cdot r and , \\ if {M}_{RB}^{PUCCH} > 1 , \\ ( {O}_{ACK} + {O}_{SR} + {O}_{CRC} ) > ( {M}_{RB , m i n}^{PUCCH} - 1 ) \cdot {N}_{sc , ctrl}^{RB} \cdot {N}_{symb - UCI}^{PUCCH} \cdot {Q}_{m} \cdot r ,$$

$${N}_{sc , ctrl}^{RB} , {N}_{symb - UCI}^{PUCCH} , {Q}_{m} ,$$

and r are defined in clause 9.2.5.2 of REF 3. For PUCCH format 3, if

$${M}_{RB , m i n}^{PUCCH}$$

in is not equal 2^{α}^{₂}·3^{α}^{₃}·5^{α}^{₅} according to [4, REF 1],

$${M}_{RB , m i n}^{PUCCH}$$

is increased to the nearest allowed value of nrofPRBs [12, REF 6]. If

$$( {O}_{ACK} + {O}_{SR} + {O}_{CRC} ) > ( {M}_{RB}^{PUCCH} - 1 ) \cdot {N}_{sc , ctrl}^{RB} \cdot {N}_{symb - UCI}^{PUCCH} \cdot {Q}_{m} \cdot r ,$$

the UE transmits the PUCCH over the

$${M}_{RB}^{PUCCH} PRBs .$$

If a UE is provided a first interlace of

$${M}_{Interlace , 0}^{PUCCH} PRBs$$

by interlace0 in InterlaceAllocation and transmits a PUCCH with O_{ACK} HARQ-ACK information bits, O_{SR}=┌log₂(K+1)┐ SR bits, and O_{CRC} CRC bits using PUCCH format 2 or PUCCH format 3, the UE transmits the PUCCH over the first interlace if

$$( {O}_{ACK} + {O}_{SR} + {O}_{CRC} ) \leq {M}_{Interlace , 0}^{PUCCH} \cdot {N}_{sc , ctrl}^{RB} \cdot {N}_{symb - UCI}^{PUCCH} \cdot {Q}_{m} \cdot r ;$$

otherwise, if the UE is provided a second interlace by interlace1 in PUCCH-format2 or PUCCH-format3, the UE transmits the PUCCH over the first and second interlaces.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to abeam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s).

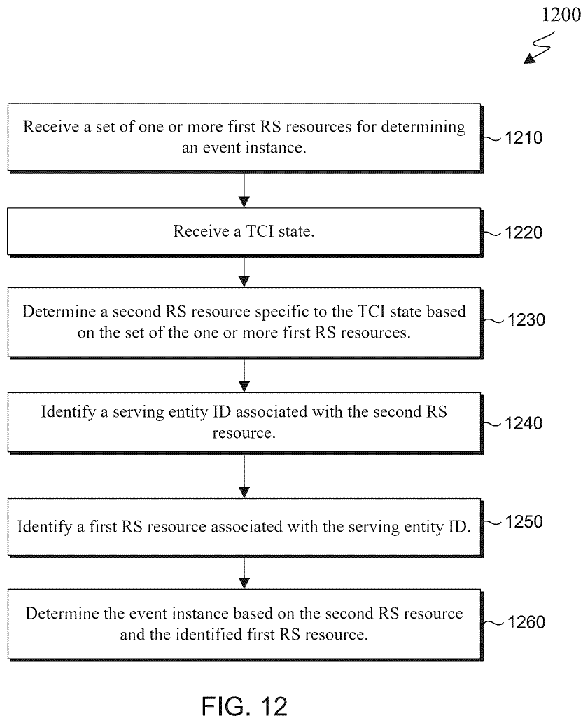

FIG. 12 illustrates an example method 1200 performed by a UE in a wireless communication system according to embodiments of the present disclosure. The method 1200 of FIG. 12 can be performed by any of the UEs 111-116 of FIG. 1, such as UE 116 of FIG. 3, and a corresponding method can be performed by any of the BSs 101-103 of FIG. 1, such as the BS 102 of FIG. 2. The method 1200 is for illustration only and other embodiments can be used without departing from the scope of the present disclosure.

The method 1200 begins with the UE receiving a set of one or more first RS resources for determining an event instance (1210). For example, in 1210, each resource in the set is associated with an entity ID. In various embodiments, a higher layer parameter that configures the set provides a list of one or more entity IDs and the one or more first RS resources in the set are one-to-one mapped to the one or more entity IDs in the list.

The UE then receives a TCI state (1220). The UE then determines a second RS resource specific to the TCI state based on the set of the one or more first RS resources (1230). In various embodiments, the second RS resource corresponds to a reference signal in the TCI state when the set of one or more first RS resources are NZP CSI-RS resources.

The UE then identifies a serving entity ID associated with the second RS resource (1240). In various embodiments, the entity ID is at least one of a PCI, a PCI index pointing to a PCI in a higher layer configured pool of PCIs, a candidate cell ID, and a candidate cell index pointing to a candidate cell in a higher layer configured pool of candidate cells. The serving entity ID is at least one of a serving cell PCI, a PCI index pointing to a serving cell PCI in a higher layer configured pool of PCIs, a current SpCell ID, and a cell index pointing to a current SpCell in a higher layer configured pool of cells. In various embodiments, a higher layer parameter that configures the TCI state provides the serving entity ID or a SS/PBCH block QCLed with the second RS resource is associated with the serving entity ID.

In various embodiments, the second RS resource corresponds to a SS/PBCH block QCLed with a reference signal in the TCI state when the set of one or more first RS resources are SS/PBCH blocks. For example, a higher layer parameter that configures the TCI state provides the serving entity ID.

The UE then identifies a first RS resource associated with the serving entity ID (1250). The UE then determines the event instance based on the second RS resource and the identified first RS resource (1260). In various embodiments, the event instance is determined when a measured L1-RSRP of the identified first RS resource is greater than a measured L1-RSRP of the second RS resource by a threshold, and the threshold is identified via higher layer signaling.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a set of one or more first reference signal (RS) resources for determining an event instance, wherein each resource in the set is associated with an entity identity (ID); and
receive a transmission configuration indication (TCI) state; and
a processor operably coupled with the transceiver, the processor configured to:
determine a second RS resource specific to the TCI state based on the set of the one or more first RS resources;
identify a serving entity ID associated with the second RS resource;
identify a first RS resource associated with the serving entity ID; and
determine the event instance based on the second RS resource and the identified first RS resource.

2. The UE of claim 1, wherein:
a higher layer parameter that configures the set provides a list of one or more entity IDs, and
the one or more first RS resources in the set are one-to-one mapped to the one or more entity IDs in the list.

3. The UE of claim 1, wherein
the entity ID is at least one of:
a physical cell identity (PCI),
a PCI index pointing to a PCI in a higher layer configured pool of PCIs,
a candidate cell ID, and
a candidate cell index pointing to a candidate cell in a higher layer configured pool of candidate cells; and
the serving entity ID is at least one of:
a serving cell PCI,
a PCI index pointing to a serving cell PCI in a higher layer configured pool of PCIs,
a current special cell (SpCell) ID, and
a cell index pointing to a current SpCell in a higher layer configured pool of cells.

4. The UE of claim 1, wherein the second RS resource corresponds to a reference signal in the TCI state when the set of one or more first RS resources are non-zero-power (NZP) channel state information reference signal (CSI-RS) resources.

5. The UE of claim 4, wherein:
a higher layer parameter that configures the TCI state provides the serving entity ID, or
a synchronization signal/physical broadcast channel (SS/PBCH) block quasi-co-located (QCLed) with the second RS resource is associated with the serving entity ID.

6. The UE of claim 1, wherein the second RS resource corresponds to a synchronization signal/physical broadcast channel (SS/PBCH) block quasi-co-located (QCLed) with a reference signal in the TCI state when the set of one or more first RS resources are SS/PBCH blocks.

7. The UE of claim 6, wherein a higher layer parameter that configures the TCI state provides the serving entity ID.

8. The UE of claim 1, wherein:
the event instance is determined when a measured layer-1 reference signal received power (L1-RSRP) of the identified first RS resource is greater than a measured L1-RSRP of the second RS resource by a threshold, and
the threshold is identified via higher layer signaling.

9. A base station (BS), comprising:
a processor; and
a transceiver operably coupled with the processor, the transceiver configured to:
transmit a set of one or more first reference signal (RS) resources for an event instance, wherein each resource in the set is associated with an entity identity (ID); and
transmit a transmission configuration indication (TCI) state,
wherein a second RS resource specific to the TCI state is based on the set of the one or more first RS resources,
wherein a serving entity ID is associated with the second RS resource,
wherein a first RS resource is associated with the serving entity ID, and
the event instance is based on the second RS resource and the first RS resource.

10. The BS of claim 9, wherein:
a higher layer parameter that configures the set provides a list of one or more entity IDs, and
the one or more first RS resources in the set are one-to-one mapped to the one or more entity IDs in the list.

11. The BS of claim 9, wherein
the entity ID is at least one of:
a physical cell identity (PCI),
a PCI index pointing to a PCI in a higher layer configured pool of PCIs,
a candidate cell ID, and
a candidate cell index pointing to a candidate cell in a higher layer configured pool of candidate cells; and
the serving entity ID is at least one of:
a serving cell PCI,
a PCI index pointing to a serving cell PCI in a higher layer configured pool of PCIs,
a current special cell (SpCell) ID, and
a cell index pointing to a current SpCell in a higher layer configured pool of cells.

12. The BS of claim 9, wherein the second RS resource corresponds to a reference signal in the TCI state when the set of one or more first RS resources are non-zero-power (NZP) channel state information reference signal (CSI-RS) resources.

13. The BS of claim 12, wherein:
a higher layer parameter that configures the TCI state provides the serving entity ID, or
a synchronization signal/physical broadcast channel (SS/PBCH) block quasi-co-located (QCLed) with the second RS resource is associated with the serving entity ID.

14. The BS of claim 9, wherein the second RS resource corresponds to a synchronization signal/physical broadcast channel (SS/PBCH) block quasi-co-located (QCLed) with a reference signal in the TCI state when the set of one or more first RS resources are SS/PBCH blocks.

15. The BS of claim 14, wherein a higher layer parameter that configures the TCI state provides the serving entity ID.

16. The BS of claim 9, wherein:
the event instance occurs when a measured layer-1 reference signal received power (L1-RSRP) of the first RS resource is greater than a measured L1-RSRP of the second RS resource by a threshold, and
the threshold is provided via higher layer signaling.

17. A method performed by a user equipment (UE), the method comprising:
receiving a set of one or more first reference signal (RS) resources for determining an event instance, wherein each resource in the set is associated with an entity identity (ID);
receiving a transmission configuration indication (TCI) state;
determining a second RS resource specific to the TCI state based on the set of the one or more first RS resources;
identifying a serving entity ID associated with the second RS resource;
identifying a first RS resource associated with the serving entity ID; and
determining the event instance based on the second RS resource and the identified first RS resource.

18. The method of claim 17, wherein:
a higher layer parameter that configures the set provides a list of one or more entity IDs, and
the one or more first RS resources in the set are one-to-one mapped to the one or more entity IDs in the list.

19. The method of claim 17, wherein
the entity ID is at least one of:
a physical cell identity (PCI),
a PCI index pointing to a PCI in a higher layer configured pool of PCIs,
a candidate cell ID, and
a candidate cell index pointing to a candidate cell in a higher layer configured pool of candidate cells; and
the serving entity ID is at least one of:
a serving cell PCI,
a PCI index pointing to a serving cell PCI in a higher layer configured pool of PCIs,
a current special cell (SpCell) ID, and
a cell index pointing to a current SpCell in a higher layer configured pool of cells.

20. The method of claim 17, wherein the second RS resource corresponds to a reference signal in the TCI state when the set of one or more first RS resources are non-zero-power (NZP) channel state information reference signal (CSI-RS) resources.
